(19) United States
(12) Patent Application Publication
(10) Pub. No.: US 2016/0142489 A1
(43) Pub. Date: May 19, 2016

(54) CONNECTION CONTROL APPARATUS, STORAGE APPARATUS, AND NON-TRANSITORY COMPUTER-READABLE RECORDING MEDIUM HAVING STORED THEREIN CONTROL PROGRAM

(71) Applicant: FUJITSU LIMITED, Kawasaki-shi (JP)

(72) Inventors: Hironobu Sazuka, Tokyo (JP); Hidekazu KAWANO, Saitama (JP); Katsuhiko Hada, Tokyo (JP); Shigeyuki Kashima, Tokyo (JP); Toru Nagasawa, Shizuoka (JP); Takashi Hirose, Tokyo (JP); Hiroyuki Watanabe, Tokyo (JP)

(73) Assignee: FUJITSU LIMITED, Kawasaki-shi (JP)

(21) Appl. No.: 14/942,277

(22) Filed: Nov. 16, 2015

(30) Foreign Application Priority Data
Nov. 19, 2014 (JP) 2014-234808
Aug. 6, 2015 (JP) 2015-156069

(51) Int. Cl. H04L 29/08; H04L 12/24; H04L 29/06

(52) U.S. Cl. CPC H04L 67/1097; H04L 65/1069; H04L 41/12

(57) ABSTRACT

A connection control apparatus includes a linkup detector that detects a linkup with the host apparatus, a port information generator that generates port group information containing port information to identify a port of the storage apparatus whose linkup is detected by the linkup detector, a host information generator that generates host group information containing host information to identify the host apparatus whose linkup is detected by the linkup detector, a logical volume information generator that generates logical volume group information containing logical volume information to identify the logical volumes of all unallocated logical volumes, and an access processing information generator that generates access processing information associating the port group information, the host group information, and the logical volume group information.

### CROSS-REFERENCE TO RELATED APPLICATIONS

This application is based upon and claims the benefit of priority of the prior Japanese Patent application No. 2014-234808, filed on Nov. 19, 2014, and the prior Japanese Patent application No. 2015-156069, filed on Aug. 6, 2015, the entire contents of which are incorporated herein by reference.

### FIELD

The embodiments discussed herein are directed to a connection control apparatus, a storage apparatus, and a non-transitory computer-readable recording medium having stored therein a control program.

### BACKGROUND

For example, the following settings are manually made for a storage apparatus (storage array apparatus) to connect the storage apparatus to a host apparatus such as a server apparatus and to cause the host apparatus to recognize a Logical Unit Number (LUN).

(1) Redundant Arrays of Inexpensive Disks (RAID) group creation (for initialization of RAID)

(2) Volume creation

(3) LUN group creation

(4) Port parameter setting

(5) Host group setting (World Wide Name (WWN) registration and host response allocation)

(6) Port group creation

(7) Host affinity creation (association of the host group, the port group, and the LUN group)

Patent Literature 1: Japanese Laid-open Patent Publication No. 2009-175968

Patent Literature 2: Japanese Laid-open Patent Publication No. 2008-197780

Thus, there are many complicated setting items for the storage apparatus to cause the host apparatus to recognize LUN, posing a problem that it takes a lot of time and efforts to make the settings.

### SUMMARY

Therefore, a connection control apparatus is included in a storage apparatus, and controls a logical volume allocated to a host apparatus. The connection control apparatus including a linkup detector that detects a linkup with the host apparatus, a port information generator that generates port group information containing port information to identify a port of the storage apparatus whose linkup is detected by the linkup detector, a host information generator that generates host group information containing host information to identify the host apparatus whose linkup is detected by the linkup detector, a logical volume information generator that generates logical volume group information containing logical volume information to identify the logical volumes of all unallocated logical volumes, and an access processing information generator that generates access processing information associating the port group information, the host group information, and the logical volume group information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a function configuration of a storage system as an example of a first embodiment;

FIG. 2 is a diagram schematically illustrating the function configuration of a connection control apparatus (CM) as an example of the first embodiment;

FIG. 3 is a diagram illustrating a relationship among an access processing table, a host group table, a port group table, and a LUN group table in CM as an example of the first embodiment;

FIG. 4 is a diagram illustrating a first example of connection control processing in CM as an example of the first embodiment;

FIG. 5 is a diagram illustrating the first example of the connection control processing in CM as an example of the first embodiment;

FIG. 6 is a diagram illustrating a first example of creation processing of the access processing table in CM as an example of the first embodiment;

FIG. 7 is a diagram illustrating a second example of the connection control processing in CM as an example of the first embodiment;

FIG. 8 is a diagram illustrating the second example of the connection control processing in CM as an example of the first embodiment;

FIG. 9 is a diagram illustrating a second example of the creation processing of the access processing table in CM as an example of the first embodiment;

FIG. 10 is a diagram illustrating a third example of the connection control processing in CM as an example of the first embodiment;

FIG. 11 is a diagram illustrating the third example of the connection control processing in CM as an example of the first embodiment;

FIG. 12 is a diagram illustrating a third example of the creation processing of the access processing table in CM as an example of the first embodiment;

FIG. 13 is a diagram illustrating a fourth example of the connection control processing in CM as an example of the first embodiment;

FIG. 14 is a diagram illustrating a fourth example of the creation processing of the access processing table in CM as an example of the first embodiment;

FIG. 15 is a diagram illustrating a fifth example of the connection control processing in CM as an example of the first embodiment;

FIG. 16 is a diagram illustrating the fifth example of the connection control processing in CM as an example of the first embodiment;

FIG. 17 is a diagram illustrating a fifth example of the creation processing of the access processing table in CM as an example of the first embodiment;

FIG. 18 is a flow chart illustrating the creation processing of the port group table in CM as an example of the first embodiment;

FIG. 19 is a flow chart illustrating the creation processing of the host group table in CM as an example of the first embodiment;

FIG. 20 is a flow chart illustrating the creation processing of the LUN group table in CM as an example of the first embodiment;

FIG. 21 is a flow chart illustrating deletion processing of the access processing table in CM as an example of the first embodiment;

FIG. 22A is a flow chart illustrating the connection control processing in the storage system as a related technology of the first embodiment;

FIG. 22B is a flow chart illustrating the connection control processing in the storage system as an example of the first embodiment;

FIG. 23A is a flow chart illustrating the connection control processing in the storage system as the related technology of the first embodiment;

FIG. 23B is a flow chart illustrating the connection control processing in the storage system as an example of the first embodiment;

FIG. 24 is a diagram schematically illustrating the function configuration of CM as an example of a second embodiment;

FIG. 25 is a diagram illustrating a DHCP management table in CM as an example of the second embodiment;

FIG. 26 is a diagram illustrating a DHCP allocation table in CM as an example of the second embodiment;

FIG. 27 is a diagram illustrating an iSNS management table in CM as an example of the second embodiment;

FIG. 28 is a diagram illustrating an iSCSI port parameter management table in CM as an example of the second embodiment;

FIG. 29 is a diagram illustrating connection setting processing in CM as an example of the second embodiment;

FIG. 30 is a flow chart illustrating the connection setting processing in CM as an example of the second embodiment;

FIG. 31 is a flow chart illustrating disconnection setting processing in CM as an example of the second embodiment;

FIG. 32 is a sequence diagram illustrating new connection setting processing in CM as an example of the second embodiment;

FIG. 33 is a sequence diagram illustrating the new connection setting processing in CM as an example of the second embodiment;

FIG. 34 is a sequence diagram illustrating the new connection setting processing in CM as an example of the second embodiment; and

FIG. 35 is a sequence diagram illustrating reconnection processing in CM as an example of the second embodiment;

### DESCRIPTION OF EMBODIMENTS

Hereinafter, an embodiment of the connection control apparatus, storage apparatus, and a non-transitory computer-readable recording medium having stored therein a control program will be described with reference to the drawings. However, the embodiment described below is only by way of example and various modifications and application of technology that are not explicitly described in the embodiment are not to be excluded. That is, the present embodiment can be carried out by modifying in various ways without deviating from the spirit thereof.

Each diagram is not intended to include only structural elements illustrated in the diagram and may include other functions.

Hereinafter, the same reference sign in diagrams indicates a similar portion and the description thereof is omitted.

### [A] Example of First Embodiment

[A-1] System Configuration

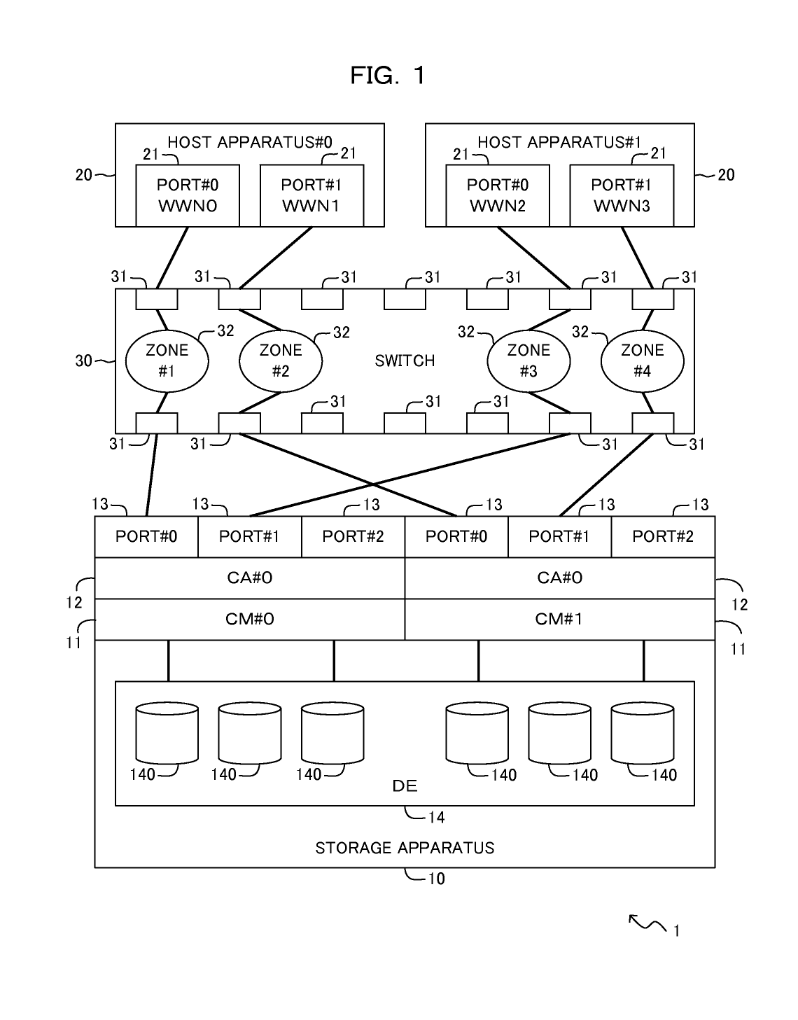

FIG. 1 is a diagram schematically illustrating a function configuration of a storage system as an example of the first embodiment.

A storage system 1 illustrated in FIG. 1 provides a storage area to a host apparatus 20 and includes a storage apparatus (storage array apparatus) 10, host apparatuses (host apparatuses#0, #1) 20 as two higher-level apparatuses, and a switch 30.

Hereinafter, when it is necessary to identify one of a plurality of host apparatuses, the host apparatus is denoted as the “host apparatus#0” or “host apparatus#1”, but when any host apparatus is referred to, the host apparatus is denoted as the “host apparatus 20”.

The host apparatus 20 is, for example, a computer (information processing apparatus) equipped with a server function. In the example illustrated in FIG. 1, the storage system 1 includes two units of the host apparatus 20, but the number of units of the host apparatus 20 included in the storage system 1 can be changed in various ways. The two units of the host apparatus 20 illustrated in FIG. 1 includes function configurations similar to each other.

The host apparatus 20 includes, in addition to a Central Processing Unit (CPU) and a memory (not illustrated), a plurality (two in the illustrated example) of host ports (ports#0, #1) 21.

Hereinafter, when it is necessary to identify one of a plurality of ports, the port is denoted as the “port#0” or “port#1”, but when any port is referred to, the port is denoted as the “port 21”.

The port 21 is an interface to connect the host apparatus 20 to an external apparatus (for example, the switch 30) and is associated with WWN as a unique identifier in a storage network constituted by the storage system 1. In the illustrated example, WWN0 is associated with the port#0 of the host apparatus#0, and WWN1 is associated with the port#1 of the host apparatus#0. Also, WWN2 is associated with the port#0 of the host apparatus#1, and WWN3 is associated with the port#1 of the host apparatus#1. That is, the host apparatus 20 can be identified by the host port 21 being identified.

The switch 30 is an apparatus that relays the connection between the host apparatus 20 and the storage apparatus 10, and includes a plurality (14 in the illustrated example) of ports 31.

The port 31 is an interface to connect the switch 30 to an external apparatus (for example, the host apparatus 20 or the storage apparatus 10).

A zone 32 (zones#1 to #4) is formed inside the switch 30 for each connection between the host apparatus 20 and the storage apparatus 10. The storage apparatus 10 includes, as a connection control apparatus (Controller Module, denoted as CM below), CM#0, #1.

In the illustrated example, the zone#1 is formed between the port#0 of the host apparatus#0 and the port#0 on the CM#0 side and the zone#2 is formed between the port#1 of the host apparatus#0 and the port#0 on the CM#1 side (described later) included in the storage apparatus 10. Also, the zone#3 is formed between the port#0 of the host apparatus#1 and the port#1 on the CM#0 side, and the zone#4 is formed between the port#1 of the host apparatus#1 and the port#1 on the CM#1 side (described later) included in the storage apparatus 10.

The connection between the host apparatus 20 and the storage apparatus 10 via the switch 30 is, for example, a fabric connection of the interface of Fiber Channel (FC), Fiber Channel over Ethernet (registered trademark) (FCoE), or Serial Attached Small computer system interface (SAS). By forming a plurality of the zones 32 inside the switch 30, WWN zoning can be performed as zoning of FC/FCoE/SAS.

The storage apparatus 10 is an apparatus mounted with a plurality of storage units 140 (described below) to provide a storage area to the host apparatus 20 and, for example, RAID is used to store data by distributing over the plurality of storage units 140 in a redundant state. The storage apparatus 10 includes two connection control apparatuses (CM#0, #1) 11, two Communication Adapters (two sets of CA#0) 12, six ports (two sets of ports#0 to #2; CA ports) 13, and a Disk Enclosure (DE) 14.

Hereinafter, when it is necessary to identify one of a plurality of CM, the CM is denoted as the “CM#0” or “CM#1”, but when any CM is referred to, the CM is denoted as the “CM 11”. Hereinafter, when it is necessary to identify one of a plurality of CA on the CM#0 side, the CA is denoted as the “CA#0 on the CM#0 side” and when it is necessary to identify one of the plurality of CA on the CM#1 side, the CA is denoted as the “CA#0 on the CM#1 side”, but when any CA is referred to, the CA is denoted as the “CA 12”. Hereinafter, when it is necessary to identify one of a plurality of ports on the CM#0 side, the port is denoted as the “port#0 on the CM#0 side”, “port#1 on the CM#0 side”, or “port#2 on the CM#0 side”. When it is necessary to identify one of the plurality of ports on the CM#1 side, the port is denoted as the “port#0 on the CM#1 side”, “port#1 on the CM#1 side”, or “port#2 on the CM#1 side”. On the other hand, when any port is referred to, the port is denoted as the “port 13”.

The storage apparatus 10 includes the CA#0 on the CM#0 side and the ports#0 to #2 on the CM#0 side as interfaces for the CM#0 and the CA#0 on the CM#1 side and the ports#0 to #2 on the CM#1 side as interfaces for the CM#1.

The DE 14 is connected to the CM 11 via an access path and includes the plurality (six in the illustrated example) of storage units 140.

The storage unit 140 is a known unit to store data readably and writably and is, for example, Hard Disk Drive (HDD) or Solid State Drive (SSD). These storage units 140 have function configurations similar to each other.

The port 13 is an interface to connect the storage apparatus 10 to an external apparatus (for example, the switch 30). In the example illustrated in FIG. 1, the storage apparatus 10 includes the six ports 13 (three for each of the CM 11), but the number of the ports 13 included in the storage apparatus 10 is not limited to the above example and may be changed in various ways.

The CA 12 is an interface controller that communicably connects the storage apparatus 10 to the host apparatus 20.

The CM 11 is a control apparatus that exercises various kinds of control and exercises various kinds of control according to a storage access request from the host apparatus 20 (access control signal: hereinafter, referred to as host I/O).

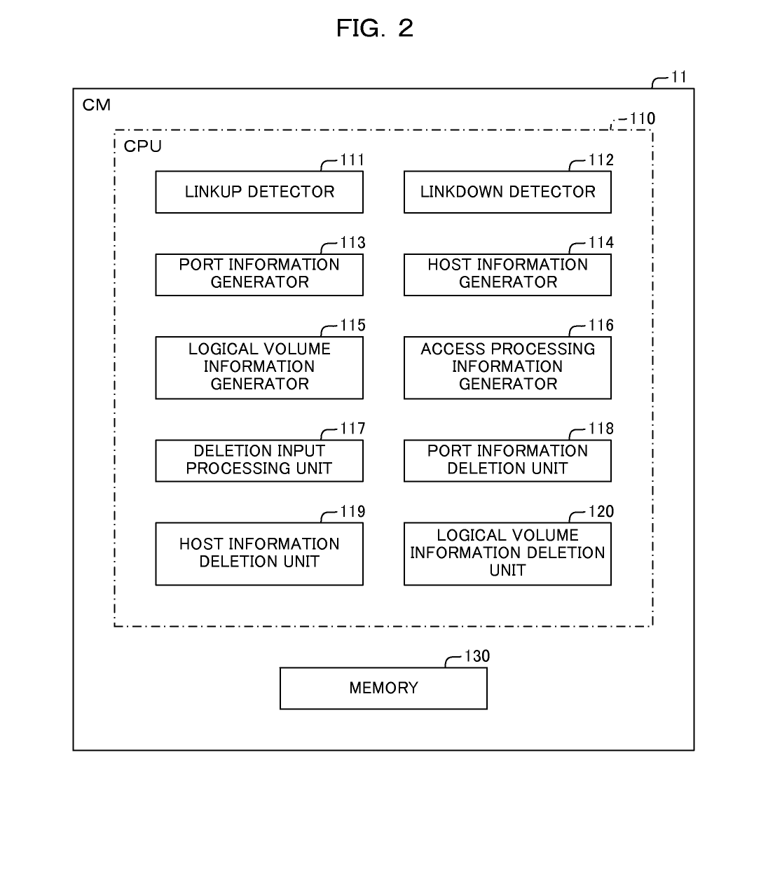

FIG. 2 is a diagram schematically illustrating the function configuration of CM as an example of the first embodiment.

As illustrated in FIG. 2, the CM 11 includes a CPU 110 and a memory 130.

The memory 130 is a storage unit including Read Only Memory (ROM) and Random Access Memory (RAM). ROM of the memory 130 has programs such as Basic Input/Output System (BIOS) written thereinto. Software programs in the memory 130 are read into the CPU 110 and executed when appropriate. RAM of the memory 130 is used as a primary recording memory or a working memory.

The CPU 110 is a processing unit that performs various kinds of control and operations, and realizes various functions by executing Operating System (OS) and programs stored in the memory 130. That is, as illustrated in FIG. 2, the CPU 110 functions as a linkup detector 111, a linkdown detector 112, a port information generator 113, a host information generator 114, a logical volume information generator 115, an access processing information generator 116, a deletion input processing unit 117, a port information deletion unit 118, a host information deletion unit 119, and a logical volume information deletion unit 120.

Programs (control programs) to realize the functions as the linkup detector 111, the linkdown detector 112, the port information generator 113, the host information generator 114, the logical volume information generator 115, the access processing information generator 116, the deletion input processing unit 117, the port information deletion unit 118, the host information deletion unit 119, and the logical volume information deletion unit 120 are provided in a form in which such programs are recorded in a computer readable recording medium, for example, a flexible disk, CD (CD-ROM, CD-R, CD-RW and the like), DVD (DVD-ROM, DVD-RAM, DVD-R, DVD+R, DVD-RW, DVD+RW, HD DVD and the like), Blu-ray disk, magnetic disk, optical disk, magneto-optical disk and the like. Then, the computer reads the program from the recording medium via a reader (not illustrated), and transfers and stores the program in an internal recording apparatus or an external recording apparatus for use. Alternatively, the program may be recorded in a recording apparatus (recording medium), for example, a magnetic disk, optical disk, magneto-optical disk or the like to provide the program to the computer from the recording apparatus via a communication path.

When the function as the linkup detector 111, the linkdown detector 112, the port information generator 113, the host information generator 114, the logical volume information generator 115, the access processing information generator 116, the deletion input processing unit 117, the port information deletion unit 118, the host information deletion unit 119, or the logical volume information deletion unit 120 is realized, the program stored in the internal recording apparatus (the memory 130 in the present embodiment) is executed by a microprocessor (the CPU 110 in the present embodiment) of the computer. At this point, a program recorded in a recording medium may be read and executed by the computer.

The linkup detector 111 detects a linkup with the host port 21. More specifically, the user inserts the connector of a link (an FC cable, an interface cable) connected to the host apparatus 20 into the CA port 13. Accordingly, the linkup detector 111 detects a linkup when the link communicably connected to the host port 21 via the switch 30 is connected to one CA port 13 of the plurality of CA ports 13 and the connection is maintained for a first specified time T1 or longer.

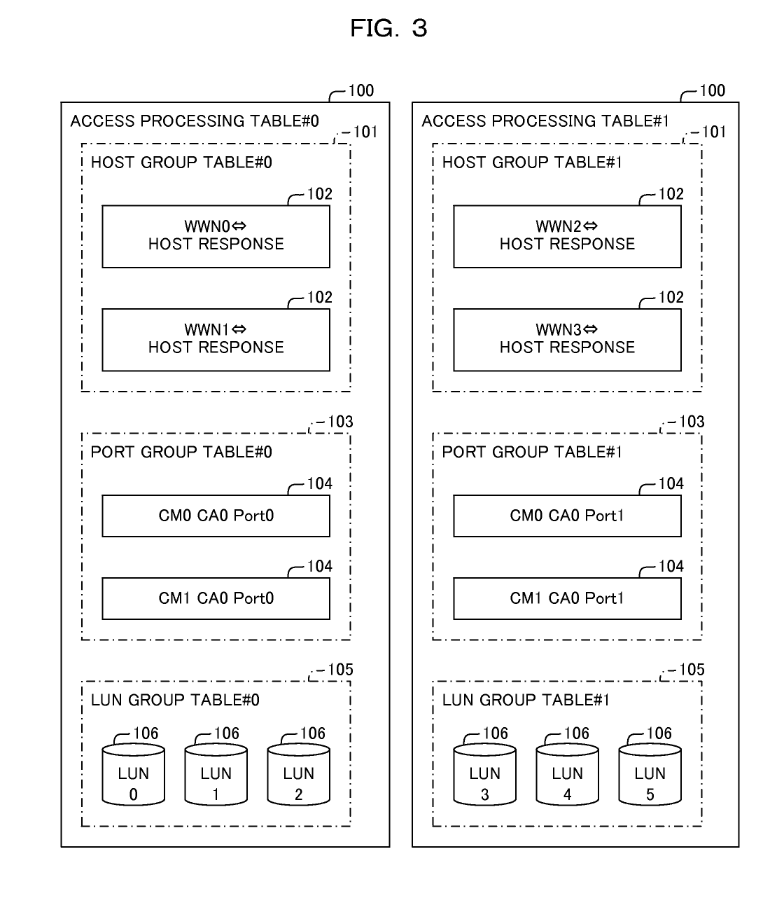

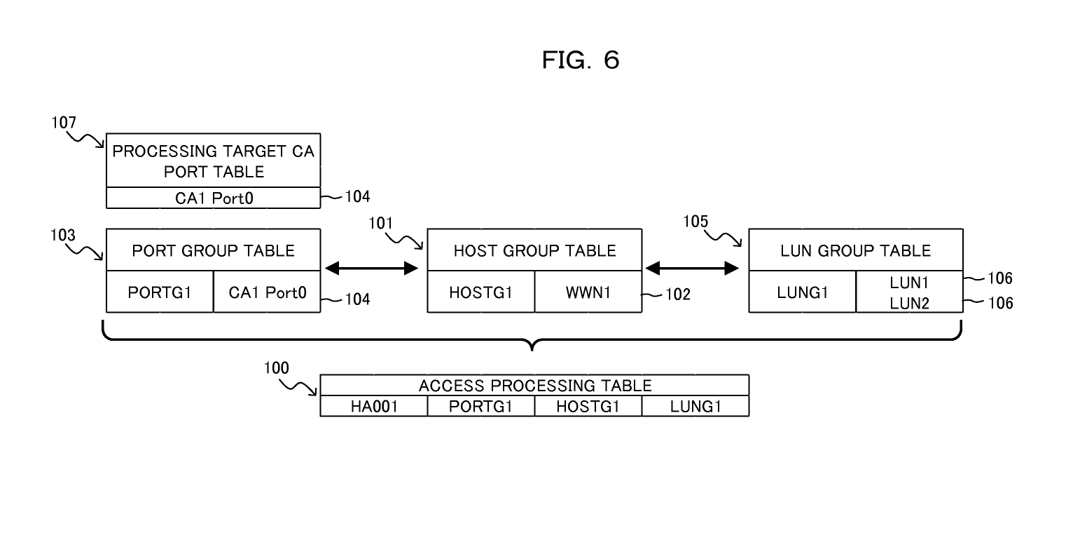

Also, the linkup detector 111 enters port information 104 (described below using FIG. 3 and the like) to identify the CA port 13 where a linkup is detected in a processing target CA port table 107 (described below using FIG. 6 and the like) to manage the ports 13 to be processed. Then, the linkup detector 111 stores information to constitute the processing target CA port table 107 in, for example, the memory 130. The CPU 110 uses the information stored in the memory 130 to expand the processing target CA port table 107 in a predetermined area of the memory.

The linkdown detector 112 detects a linkdown from the host port 21. More specifically, the user removes the connector of a link (an FC cable, an interface cable) in a linkup state from the CA port 13. Accordingly, when a link in a connected state to the host port 21 via the switch 30 is removed from the one CA port 13 of the plurality of CA ports 13 and the removed state is maintained for a third specified time T3 or longer, the linkdown detector 112 detects a linkdown.

Also, the linkdown detector 112 enters the port information 104 to identify the CA port 13 where a linkdown is detected in the processing target CA port table 107 to manage the ports 13 to be processed. Then, the linkdown detector 112 stores information to constitute the processing target CA port table 107 in, for example, the memory 130. The CPU 110 uses the information stored in the memory 130 to expand the processing target CA port table 107 in the predetermined area of the memory.

FIG. 3 is a diagram illustrating a relationship among an access processing table, a host group table, a port group table, and a LUN group table in CM as an example of the first embodiment.

In FIG. 3, the relationship among an access processing table 100, a host group table 101, a port group table 103, and a LUN group table 105 when, like the storage system 1 illustrated in FIG. 1, the host apparatus 20, the switch 30, and the storage apparatus 10 are connected is illustrated.

The port information generator 113 generates the port group table (port group information) 103 containing the port information 104 to identify the CA port 13 where a linkup is detected by the linkup detector 111. Then, the port information generator 113 stores information to constitute the generated port group table 103 in, for example, the memory 130. The CPU 110 uses the information stored in the memory 130 to expand the port group table 103 in the predetermined area of the memory 130.

When predetermined conditions are satisfied, the port information generator 113 enters the port information 104 of each of the plurality of host ports 21 in the port group table 103 as the same group. The case when predetermined conditions are satisfied is a case when the linkup detector 111 detects a linkup with the other port 21 on the host side before a second specified time T2 passes after detecting a linkup with the certain port 21 on the host side.

In the example illustrated in FIG. 3, two pieces of the port information 104 indicated by “CM0 CA0 Port0” and “CM1 CA0 Port0” are entered in the port group table#0 103 as the same group. In the port group table#1 103, two pieces of the port information 104 indicated by “CM0 CA0 Port1” and “CM1 CA0 Port1” are entered as the same group. That is, the port information generator 113 enters the port information 104 of the port#0 on the CM#0 side and that of the port#0 on the CM#1 side in the port group table#0 103 as the same group. Also, the port information generator 113 enters the port information 104 of the port#1 on the CM#0 side and that of the port#1 on the CM#1 side in the port group table#1 103 as the same group.

The host information generator 114 generates the host group table (host group information) 101 containing host information 102 to identify the host port 21 where a linkup is detected by the linkup detector 111. Then, the host information generator 114 stores information to constitute the generated host group table 101 in, for example, the memory 130. The CPU 110 uses the information stored in the memory 130 to expand the host group table 101 in the predetermined area of the memory 130.

When predetermined conditions are satisfied, the host information generator 114 enters the host information 102 of each of the plurality of host ports 21 in the host group table 101 as the same group. The case when predetermined conditions are satisfied is a case when the linkup detector 111 detects a linkup with the other port 21 on the host side before the second specified time T2 passes after detecting a linkup with the certain port 21 on the host side.

In the example illustrated in FIG. 3, two pieces of the host information 102 indicated by “WWN0 [symbol] host response” and “WWN1 [symbol] host response” are entered in the host group table#0 101 as the same group. In the host group table#1 101, two pieces of the host information 102 indicated by “WWN2 [symbol] host response” and “WWN3 [symbol] host response” are entered as the same group. That is, the host information generator 114 enters the host information 102 of each of the ports#0, #1 of the host apparatus#0 in the host group table#0 101 as the same group. Also, the host information generator 114 enters the host information 102 of each of the ports#0, #1 of the host apparatus#1 in the host group table#1 101 as the same group.

The logical volume information generator 115 generates the LUN group table (logical volume group information) 105 containing logical volume information 106 to identify logical volumes of all unallocated logical volumes. Then, the logical volume information generator 115 stores information to constitute the generated LUN group table 105 in, for example, the memory 130. The CPU 110 uses the information stored in the memory 130 to expand the LUN group table 105 in the predetermined area of the memory 130. Before the generation of the LUN group table 105 by the logical volume information generator 115, the user defines one or a plurality of Logical Units (LU; Logical Volume) to be allocated to the host apparatus 20.

In the example illustrated in FIG. 3, three pieces of the logical volume information 106 indicated by “LUN0”, “LUN1”, and “LUN2” are entered in the LUN group table#0 105 as the same group. Also, in the LUN group table#1 105, three pieces of the logical volume information 106 indicated by “LUN3”, “LUN4”, and “LUN5” are entered as the same group. That is, the logical volume information generator 115 enters the logical volume information 106 indicated by LUN0 to LUN2 in the LUN group table#0 105 as the same group. Also, the logical volume information generator 115 enters the logical volume information 106 indicated by LUN3 to LUN5 in the LUN group table#1 105 as the same group.

When predetermined conditions are satisfied, the logical volume information generator 115 enters, in addition to the logical volume information 106 registered in the existing logical volume group table 105, the logical volume information 106 of all newly added and unallocated logical volumes in the LUN group table 105 as the same group. The case when predetermined conditions are satisfied is a case when the linkup detector 111 detects, after the linkdown detector 112 detects a linkdown from the host port 21 whose the access processing information 100 is generated, a re-linkup with the same host port 21.

The access processing information generator 116 generates the access processing table (access processing information) 100 associating the port group table 103, the host group table 101, and the LUN group table 105. Then, the access processing information generator 116 stores information to constitute the generated access processing table 100 in, for example, the memory 130. The CPU 110 uses the information stored in the memory 130 to expand the access processing table 100 in the predetermined area of the memory 130.

In the example illustrated in FIG. 3, the access processing information generator 116 generates the access processing table#0 100 associating the port group table#0 103, the host group table#0 101, and the LUN group table#0 105. Also, the access processing information generator 116 generates the access processing table#1 100 associating the port group table#1 103, the host group table#1 101, and the LUN group table#1 105.

The deletion input processing unit 117 has a deletion instruction of the port information 104 or the host information 102 input thereinto. Also, the deletion input processing unit 117 has a deletion instruction of the LUN group table 105 input thereinto. The user inputs a deletion instruction via, for example, Man Machine Interface (MMI) of a control terminal (not illustrated) included in the storage system 1.

The port information deletion unit 118 deletes, when an input into the deletion input processing unit 117 arises, the port information 104 of the host port 21 from which a linkdown is detected by the linkdown detector 112 from the port group table 103.

The host information deletion unit 119 deletes, when an input into the deletion input processing unit 117 arises, the host information 102 of the host port 21 from which a linkdown is detected by the linkdown detector 112 from the host group table 101.

The logical volume information deletion unit 120 deletes the LUN group table 105 when an input into the deletion input processing unit 117 arises and the linkdown detector 112 detects linkdowns from all the host ports 21 connected to the storage apparatus 10. More specifically, the logical volume information deletion unit 120 deletes the LUN group table 105 when the input of a deletion instruction occurs and after a linkdown from the certain port 21 on the host side is detected, linkdowns from all the other ports 21 are detected within a fourth specified time T4.

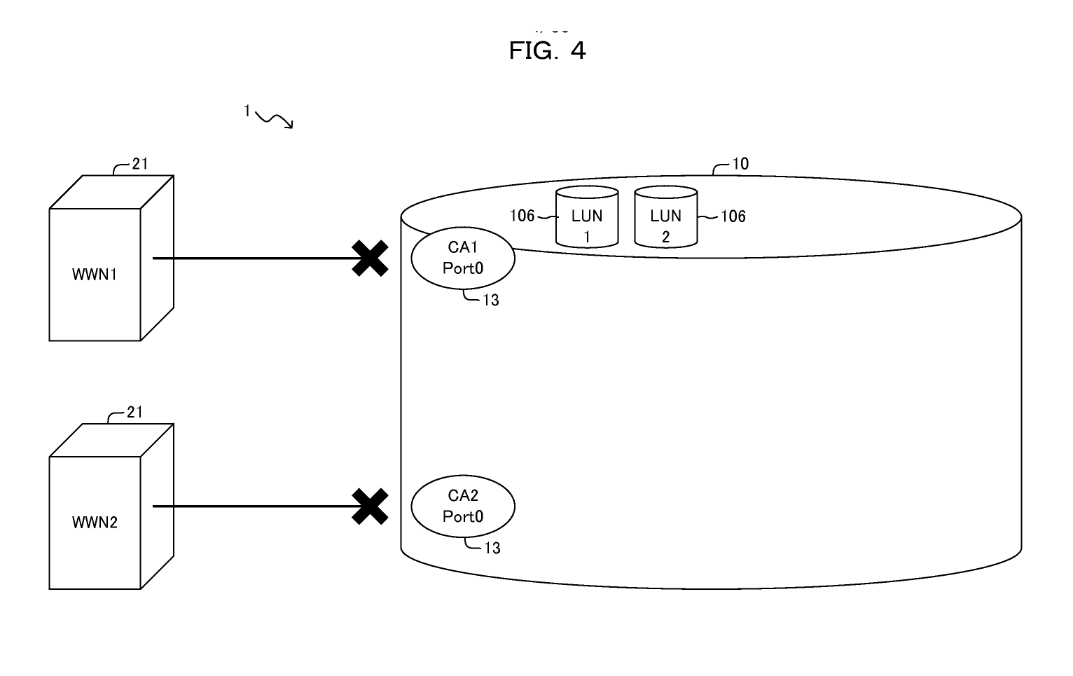

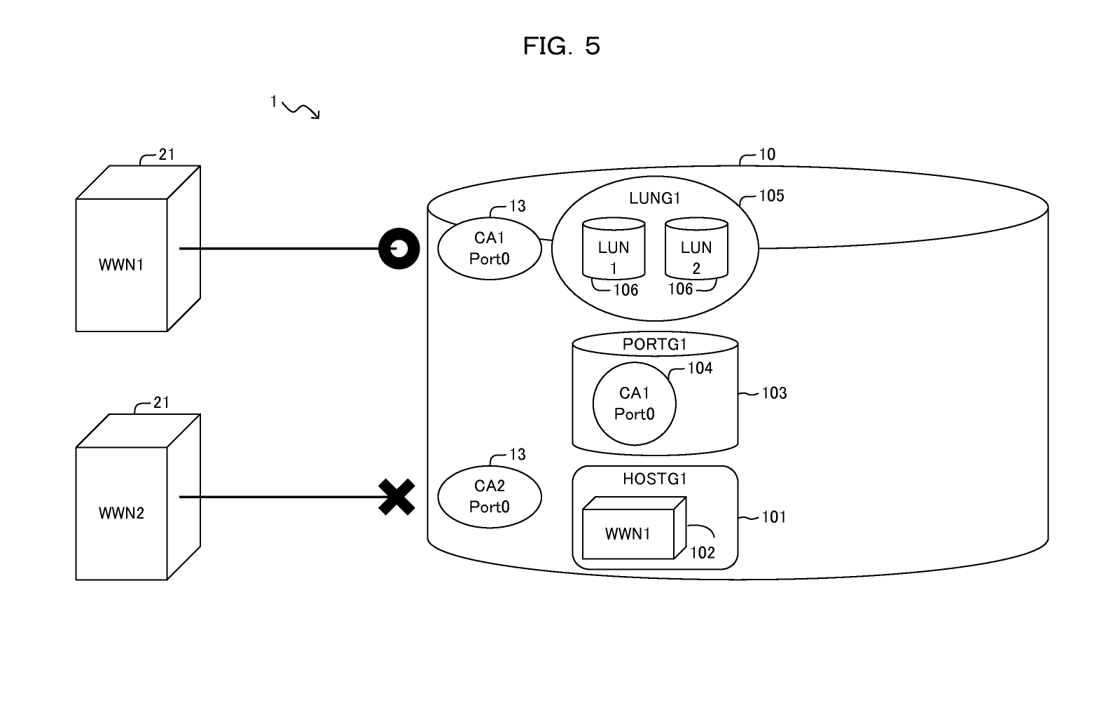

FIGS. 4 and 5 are diagrams illustrating a first example of connection control processing in CM as an example of the first embodiment and FIG. 6 is a diagram illustrating a first example of creation processing of an access processing table thereof.

In examples illustrated in FIGS. 4, 5, 7, 8, 10, 11, 13, 15 and 16, only the host port 21, the storage apparatus 10 and the CA port 13 are illustrated as function configurations included in the storage system 1, and the illustration of other function configurations is omitted for the sake of simplicity. Also in the examples illustrated in FIGS. 4, 5, 7, 8, 10, 11, 13, 15 and 16, “X” in the diagrams indicates that the host port 21 and the CA port 13 are in an unconnected state, and “0” in the diagrams indicates that the host port 21 and the CA port 13 are in a connected state.

In FIGS. 4 to 6, an example in which LU is allocated to the one host port 21 is illustrated.

In the state illustrated in FIG. 4, the host ports 21 identified by “WWN1” and “WWN2” are both in an unconnected state to the CA port 13. It is assumed that the user wants to define two pieces of the logical volume information 106 indicated by “LUN1” and “LUN2”. “LUN1” and “LUN2” correspond to unallocated logical volumes.

As illustrated in FIG. 5, the linkup detector 111 detects a linkup with the host apparatus 20 by the connected link of the host port 21 identified by “WWN1” being connected by the user to the CA port 13 identified by “CA1 Port0”. In such a case, as illustrated in FIG. 6, the linkup detector 111 enters the port information 104 indicated by “CA1 Port0” in the processing target CA port table 107.

As illustrated in FIGS. 5 and 6, the port information generator 113 generates the port group table 103 containing the port information 104 indicated by “CA1 Port0” for the CA port 13 where a linkup is detected by the linkup detector 111. As illustrated in FIG. 6, the port information generator 113 attaches an identifier, for example, “PORTG1” to the port group entered in the generated port group table 103.

As illustrated in FIGS. 5 and 6, the host information generator 114 generates the host group table 101 containing the host information 102 indicated by “WWN1” for the host port 21 where a linkup is detected by the linkup detector 111. As illustrated in FIG. 6, the host information generator 114 attaches an identifier, for example, “HOSTG1” to the port group entered in the generated host group table 101.

As illustrated in FIGS. 5 and 6, the logical volume information generator 115 generates the LUN group table 105 containing two pieces of the logical volume information 106 indicated by “LUN1” and “LUN2” among all unallocated logical volumes as the same group. As illustrated in FIG. 6, the logical volume information generator 115 attaches an identifier, for example, “LUNG1” to the LUN group entered in the generated LUN group table 105.

As illustrated in FIG. 6, the access processing information generator 116 generates the access processing table 100 associating the “PORTG1” of the port group table 103, “HOSTG1” of the host group table 101, and “LUNG1” of the LUN group table 105. The access processing information generator 116 attaches an identifier, for example, “HA001” to the access processing group entered in the generated access processing table 100.

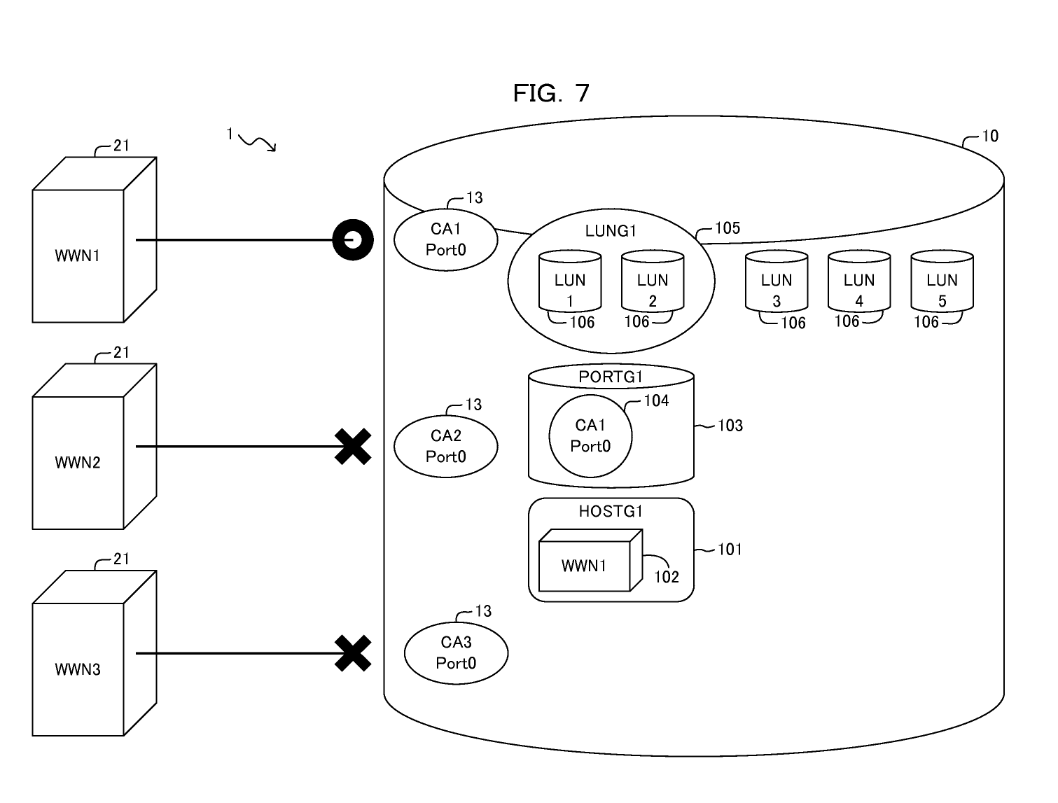

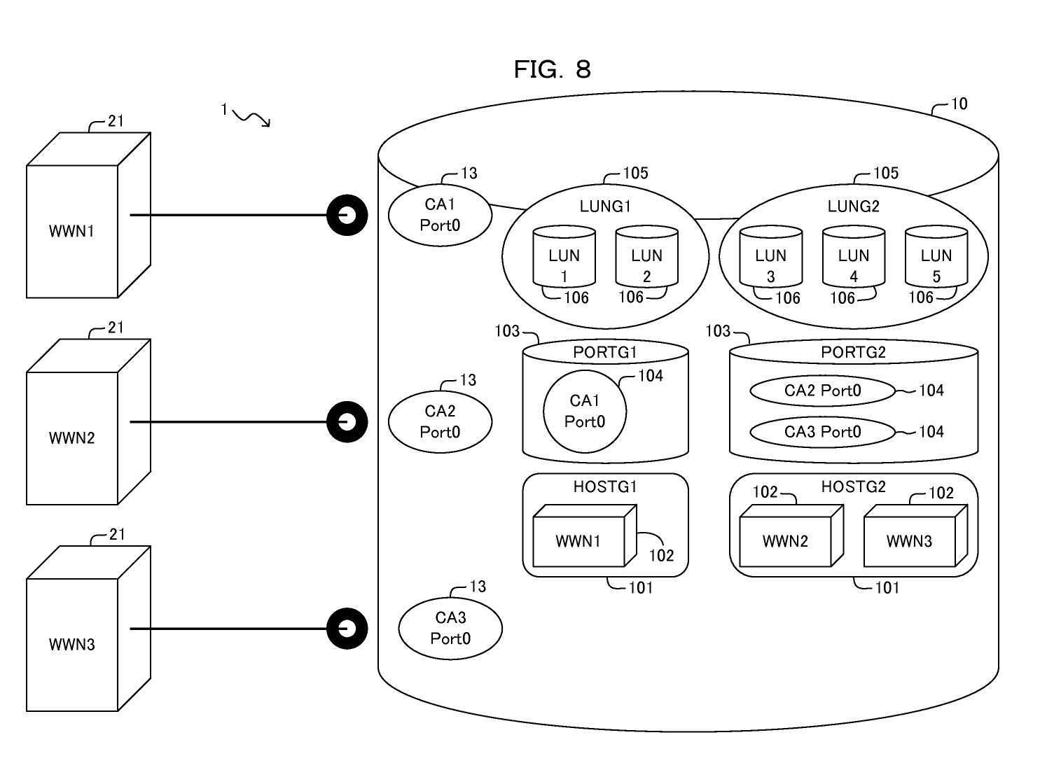

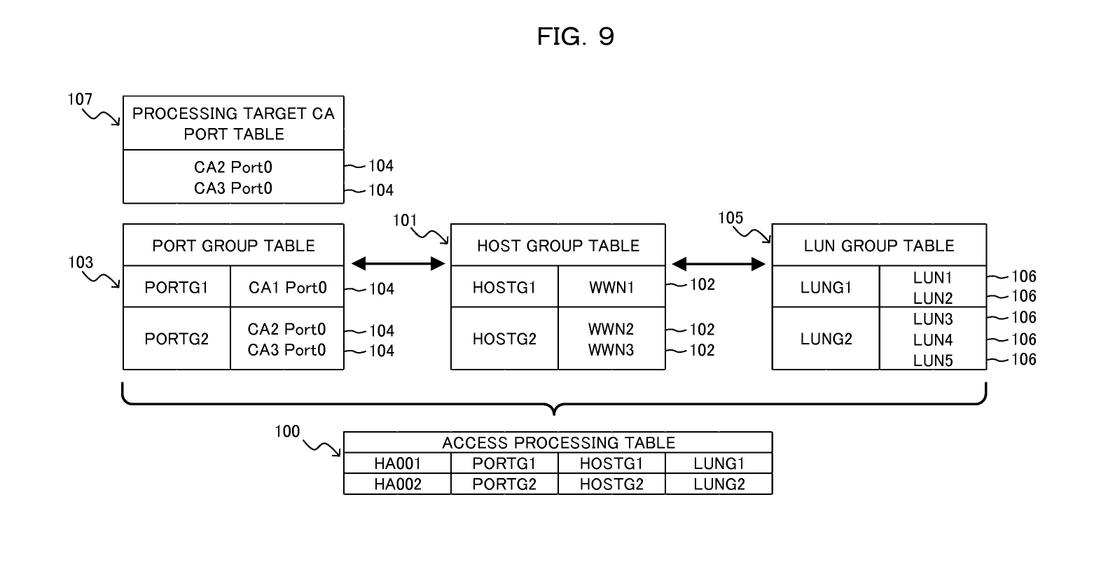

FIGS. 7 and 8 are diagrams illustrating a second example of the connection control processing in CM as an example of the first embodiment and FIG. 9 is a diagram illustrating a second example of the creation processing of an access processing table thereof.

In FIGS. 7 to 9, an example in which LU is allocated to the plurality of host ports 21 is illustrated.

FIG. 7 illustrates a state in which, in addition to the example illustrated in FIG. 5, the storage system 1 further includes the host port 21 in an unconnected state to the CA port 13 and identified by “WWN3” and LU in an unallocated state is added by the user.

In the state illustrated in FIG. 7, the host port 21 identified by “WWN1” is in a connected state to the CA port 13, and the host ports 21 identified by “WWN2” and “WWN3” are both in an unconnected state to the CA port 13. It is also assumed that the user defines three pieces of the logical volume information 106 indicated by “LUN3”, “LUN4” and “LUN5”. “LUN3”, “LUN4” and “LUN5” correspond to unallocated logical volumes.

As illustrated in FIG. 8, when the user connects the connected link of the host port 21 identified by “WWN2” to the CA port 13 identified by “CA2 Port0”, the linkup detector 111 detects a linkup with the host apparatus 20. When the user connects the connected link of the host port 21 identified by “WWN3” to the CA port 13 identified by “CA3 Port0” within the second specified time T2 after the detection of the linkup, the linkup detector 111 detects a linkup with the host apparatus 20. The difference of connection times of the two links is within the second specified time T2. In such a case, as illustrated in FIG. 9, the linkup detector 111 enters two pieces of the port information 104 indicated by “CA2 Port0” and “CA3 Port0” in the processing target CA port table 107.

As illustrated in FIGS. 8 and 9, the port information generator 113 enters two pieces of the port information 104 indicated by “CA2 Port0” and “CA3 Port0” for the CA port 13 where the linkup is detected by the linkup detector 111 in the port group table 103 as the same group.

As illustrated in FIG. 9, in addition to the port group entered in the port group table 103 and identified by “PORTG1”, the port information generator 113 attaches an identifier, for example, “PORTG2” to the newly entered port group.

As illustrated in FIGS. 8 and 9, the host information generator 114 enters two pieces of the host information 102 indicated by “WWN2” and “WWN3” for the host port 21 where the linkup is detected by the linkup detector 111 in the host group table 101 as the same group. As illustrated in FIG. 9, in addition to the host group entered in the host group table 101 and identified by “HOSTG1”, the host information generator 114 attaches an identifier, for example, “HOSTG2” to the newly entered host group.

As illustrated in FIGS. 8 and 9, the logical volume information generator 115 generates the LUN group table 105 containing three pieces of the logical volume information 106 indicated by “LUN3”, “LUN4”, and “LUN5” among all unallocated logical volumes as the same group. As illustrated in FIG. 9, in addition to the LUN group entered in the LUN group table 105 and identified by “LUNG1”, the logical volume information generator 115 attaches an identifier, for example, “LUNG2” to the newly entered LUN group.

As illustrated in FIG. 9, the access processing information generator 116 associates and enters “PORTG2” of the port group table 103, “HOSTG2” of the host group table 101, and “LUNG2” of the LUN group table 105 in the access processing table 100. In addition to the access processing group entered in the access processing table 100 and identified by “HA001”, the access processing information generator 116 attaches an identifier, for example, “HA002” to the newly entered access processing group.

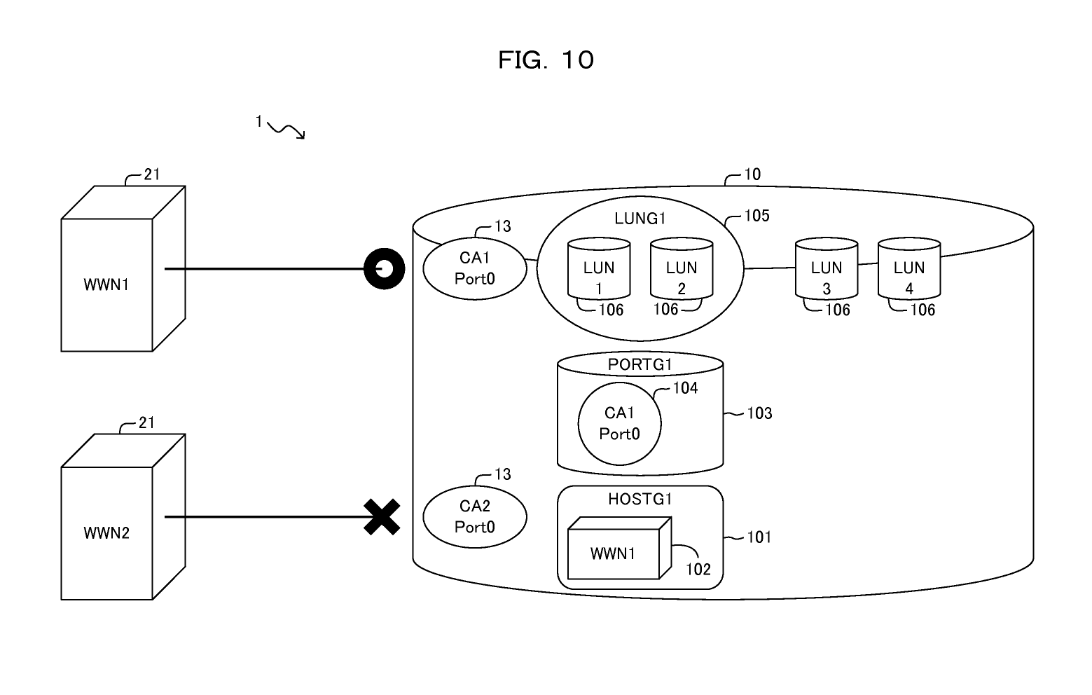

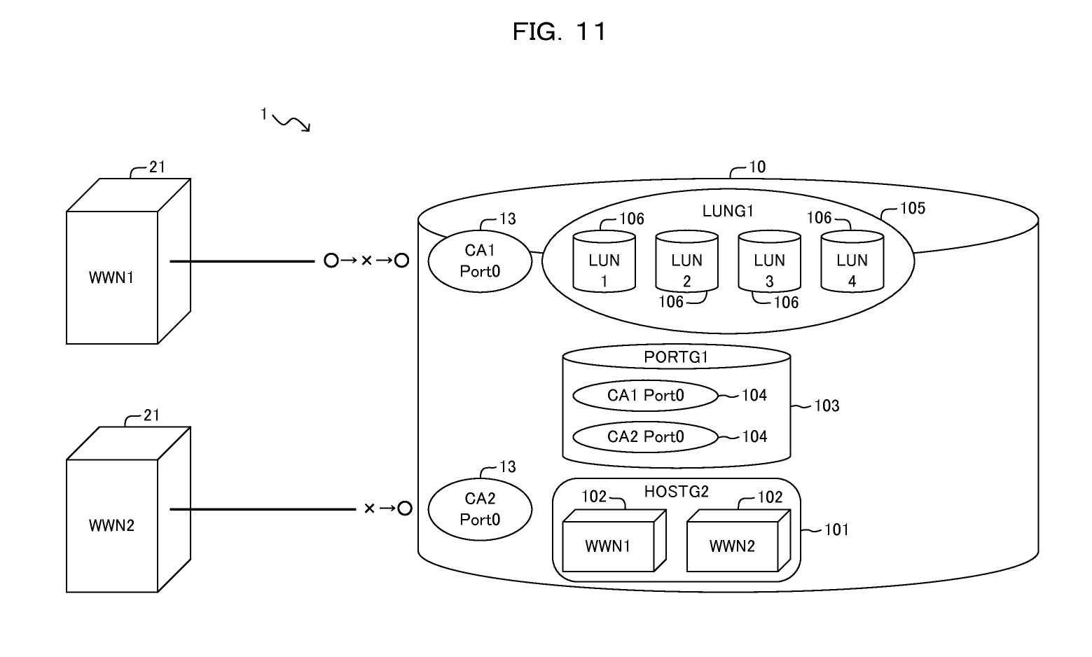

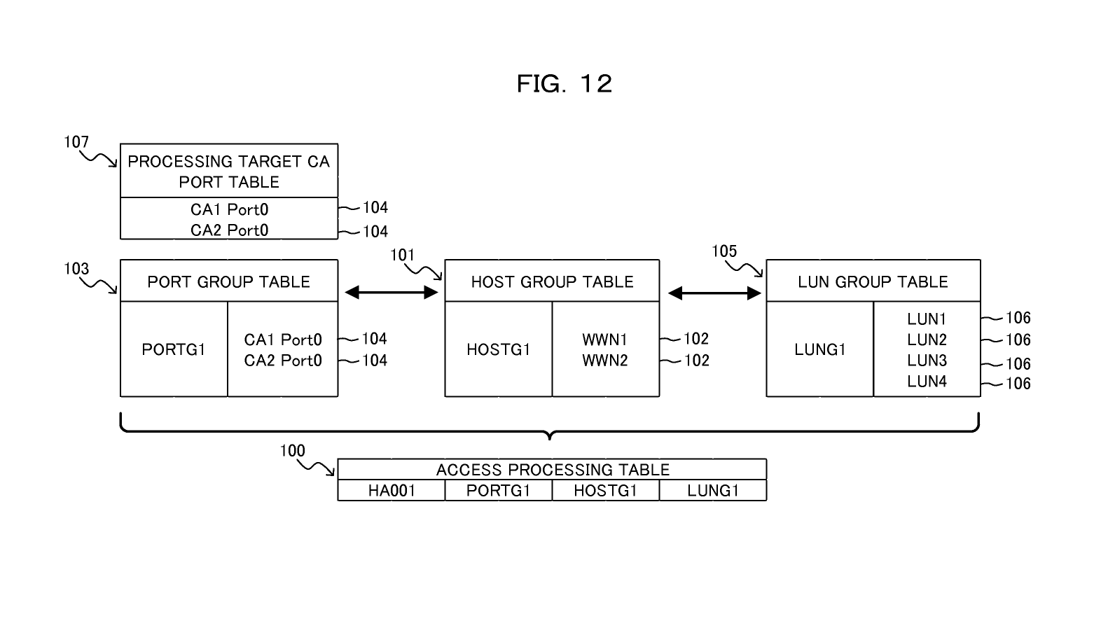

FIGS. 10 and 11 are diagrams illustrating a third example of the connection control processing in CM as an example of the first embodiment, and FIG. 12 is a diagram illustrating a third example of the creation processing of an access processing table thereof.

FIGS. 10 to 12 illustrate an example in which the new host port 21 is added to an existing access processing group.

FIG. 10 illustrates a state in which, in addition to the example illustrated in FIG. 5, LU in an unallocated state is added by the user.

In the state illustrated in FIG. 10, the host port 21 identified by “WWN1” is in a connected state to the CA port 13, and the host port 21 identified by “WWN2” is in an unconnected state to the CA port 13. It is also assumed that the user defines two pieces of the logical volume information 106 indicated by “LUN3” and “LUN4”.

The user inserts or removes the connector of a link connected to the CA port 13. Accordingly, as illustrated in FIG. 11, after the linkdown detector 112 detects a linkdown from the host port 21 identified by “WWN1”, the linkup detector 111 detects a re-linkup with the host port 21 identified by “WWN1”. Also, the user connects the connector of the link to the CA port 13 within the second specified time T2 after the detection of the re-linkup. Accordingly, when the connected link of the host port 21 identified by “WWN2” is connected to the CA port 13 identified by “CA2 Port0”, the linkup detector 111 detects a linkup with the host apparatus 20. The difference of connection times of the two links is within the second specified time T2. Then, as illustrated in FIG. 12, the linkup detector 111 enters two pieces of the port information 104 indicated by “CA1 Port0” and “CA2 Port0” in the processing target CA port table 107.

As illustrated in FIGS. 11 and 12, in addition to the port information 104 indicated by “CA1 Port0”, the port information generator 113 enters the port information 104 indicated by “CA2 Port0” in the port group table 103 as the same group. As illustrated in FIG. 12, the port information generator 113 enters the port information 104 indicated by “CA2 Port0” in the port group entered in the port group table 103 and identified by “PORTG1”.

As illustrated in FIGS. 11 and 12, in addition to the host information 102 indicated by “WWN1”, the host information generator 114 enters the host information 102 indicated by “WWN2” in the host group table 101 as the same group. As illustrated in FIG. 12, the host information generator 114 enters the host information 102 indicated by “WWN2” in the host group entered in the host group table 101 and identified by “HOSTG1”.

As illustrated in FIGS. 11 and 12, in addition to the logical volume information 106 indicated by “LUN1” and “LUN2”, the logical volume information generator 115 enters the logical volume information 106 indicated by “LUN3” and “LUN4” in the LUN group table 105 as the same group. As illustrated in FIG. 12, logical volume information generator 115 enters logical volume information 106 indicated by “LUN3” and “LUN4” in the LUN group entered in the LUN group table 105 and identified by “LUNG1”.

As illustrated in FIG. 12, the access processing information generator 116 associates and enters “PORTG1” of the port group table 103, “HOSTG1” of the host group table 101, and “LUNG1” of the LUN group table 105 in the access processing table 100. The access processing information generator 116 attaches an identifier, for example, “HA001” to the access processing group entered in the created access processing table 100.

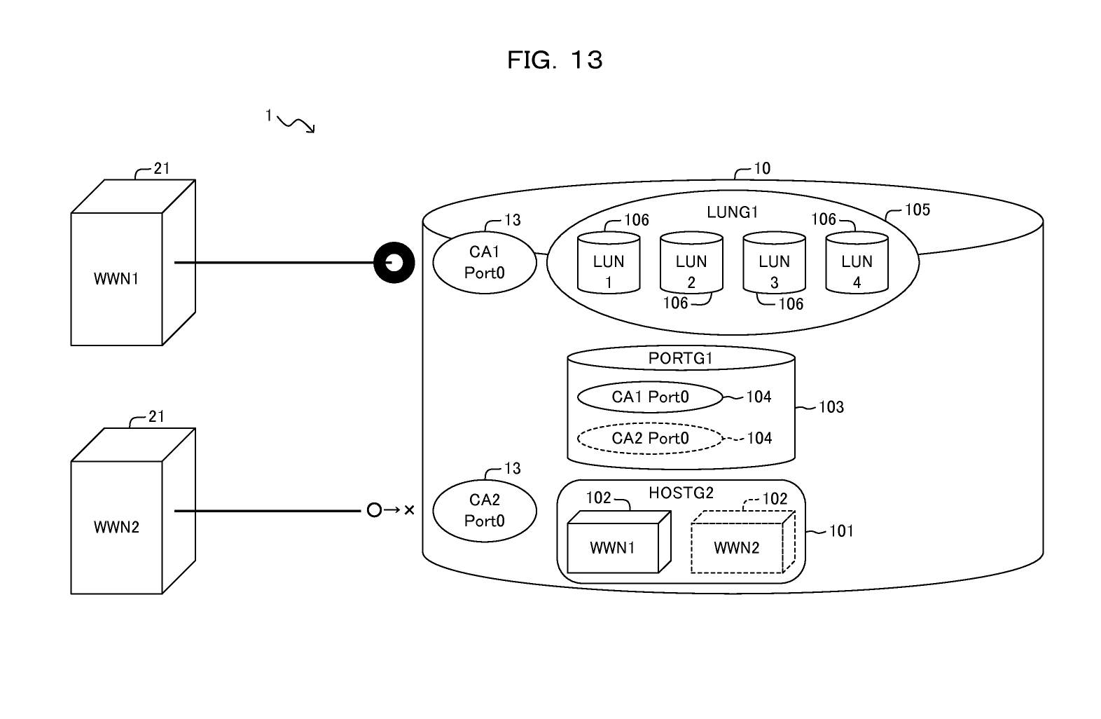

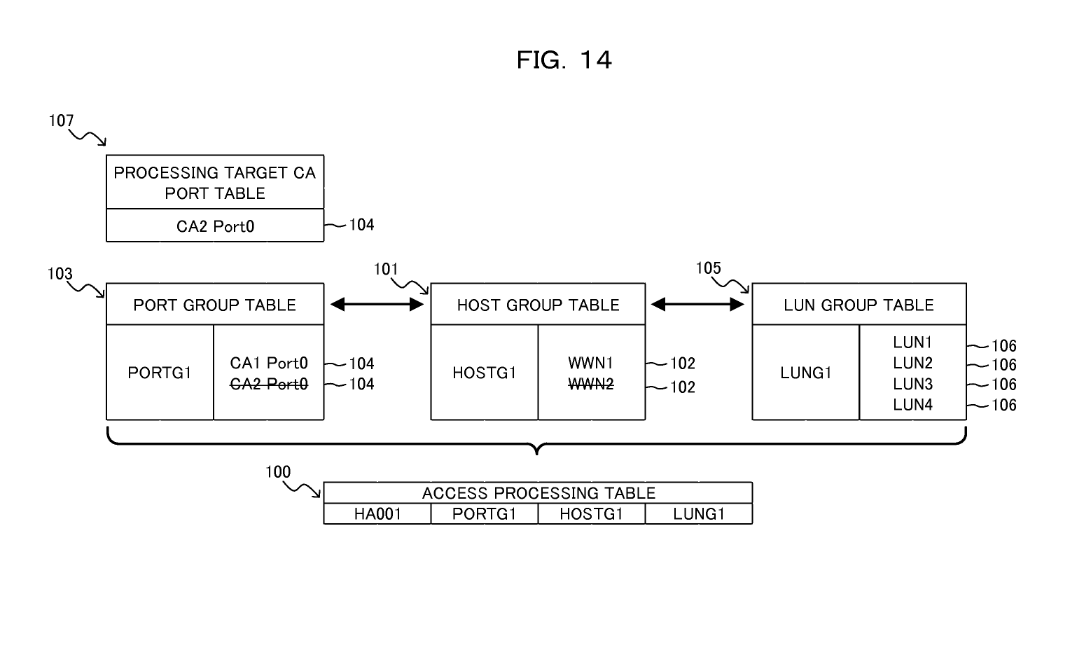

FIG. 13 is a diagram illustrating a fourth example of the connection control processing in CM as an example of the first embodiment, and FIG. 14 is a diagram illustrating a fourth example of the creation processing of an access processing table thereof.

FIGS. 13 and 14 illustrate an example in which the allocation of LU to a portion of the host ports 21 is released.

FIG. 13 illustrates a state similar to the state after the connection of the host ports 21 identified by “WWN1” and “WWN2” illustrated in FIG. 10.

In the state illustrated in FIG. 13, as the initial state, the host port 21 identified by “WWN1” is in a connected state to the CA port 13, and the host port 21 identified by “WWN2” is in a connected state to the CA port 13.

As illustrated in FIG. 13, when the connected link of the host port 21 identified by “WWN2” is removed from the CA port 13 identified by “CA2 Port0” by the user, the linkdown detector 112 detects a linkdown from the host apparatus 20. Then, as illustrated in FIG. 14, the linkup detector 111 enters the port information 104 indicated by “CA2 Port0” in the processing target CA port table 107.

The user inputs a deletion instruction into the deletion input processing unit 117 of the port information 104 and the host information 102 of the host port 21 identified by “WWN2”.

As illustrated in FIGS. 13 and 14, the port information deletion unit 118 deletes the port information 104 indicated by “CA2 Port0” from the port group table 103 (see the broken line in FIG. 13 and the strikeout in FIG. 14). That is, as illustrated in FIG. 14, the port information 104 indicated by “CA1 Port0” remains in the port group identified by “PORTG1” of the port group table 103.

As illustrated in FIGS. 13 and 14, the host information deletion unit 119 deletes the host information 102 indicated by “WWN2” from the host group table 101 (see the broken line in FIG. 13 and the strikeout in FIG. 14). That is, as illustrated in FIG. 14, the host information 102 indicated by “WWN1” remains in the host group identified by “HOSTG1” of the host group table 101.

As illustrated in FIG. 14, the access processing information generator 116 associates and enters “PORTG1” of the port group table 103, “HOSTG1” of the host group table 101, and “LUNG1” of the LUN group table 105 in the access processing table 100. The access processing information generator 116 attaches an identifier, for example, “HA001” to the access processing group entered in the created access processing table 100.

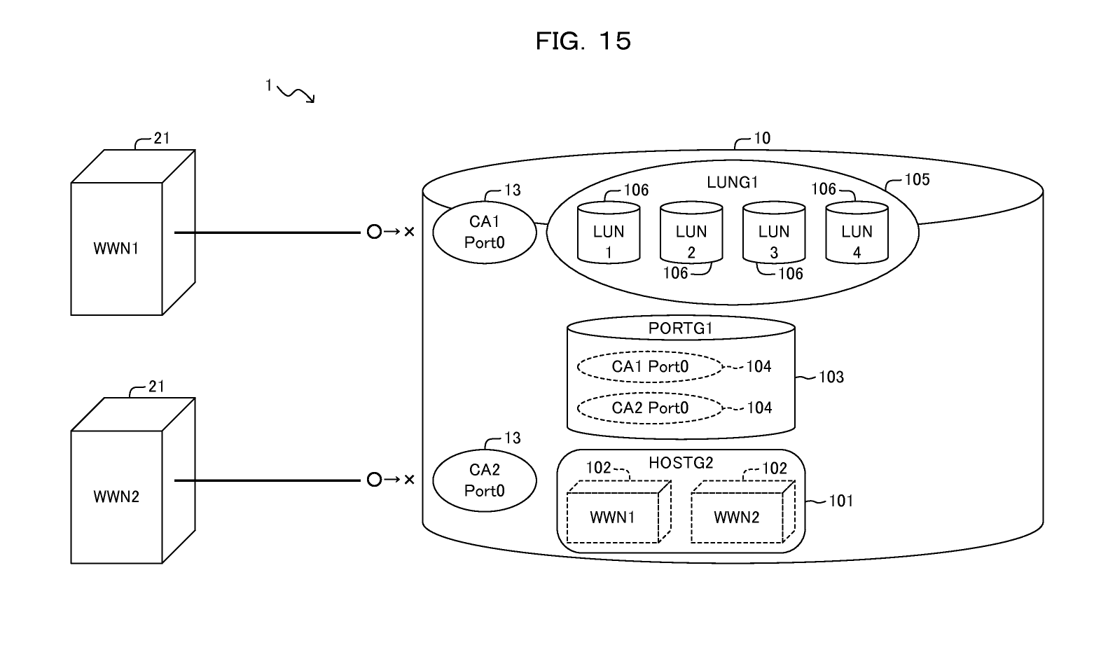

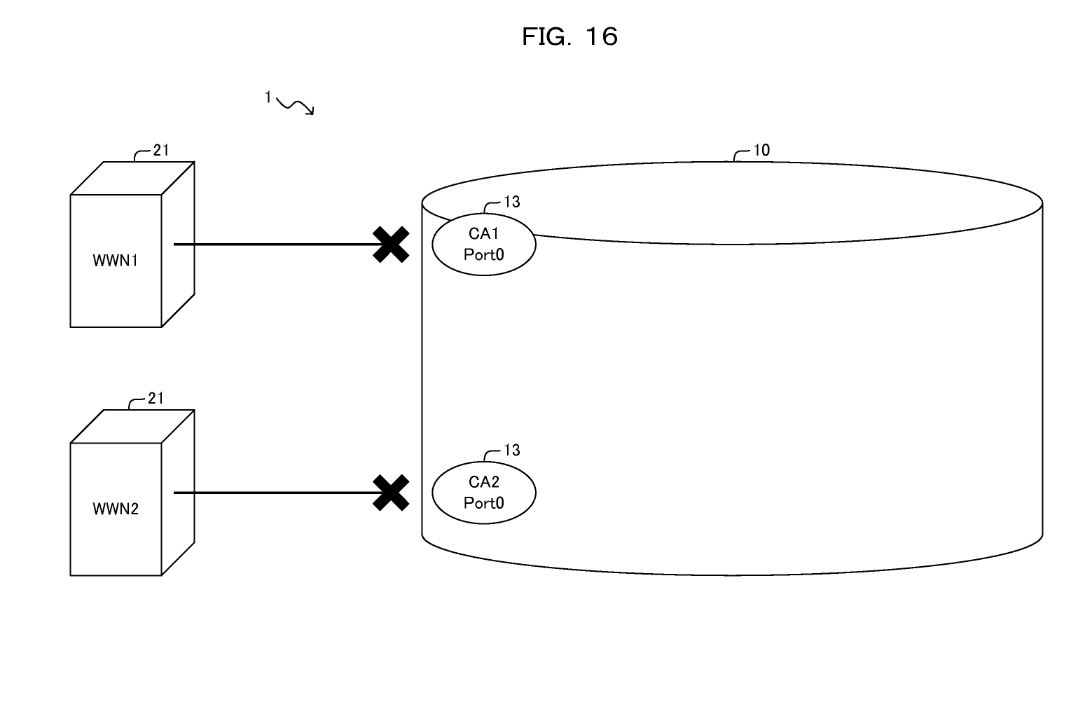

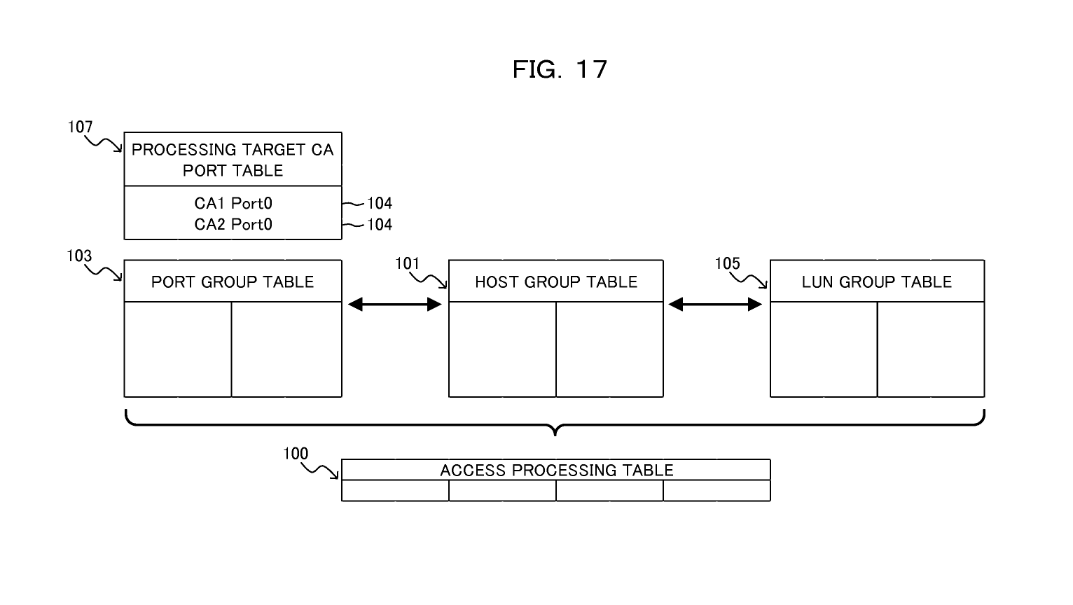

FIGS. 15 and 16 are diagrams illustrating a fifth example of the connection control processing in CM as an example of the first embodiment and FIG. 17 is a diagram illustrating a fifth example of the creation processing of an access processing table thereof.

FIGS. 15 to 17 illustrate an example in which the allocation of LU to all the host ports 21 is released.

FIG. 15 illustrates a state similar to the state after the connection of the host ports 21 identified by “WWN1” and “WWN2” illustrated in FIG. 10.

In the state illustrated in FIG. 15, as the initial state, the host port 21 identified by “WWN1” is in a connected state to the CA port 13 identified by “CA1 Port0”, and the host port 21 identified by “WWN2” is in a connected state to the CA port 13 identified by “CA2 Port0”.

As illustrated in FIG. 15, when the connected link of the host port 21 identified by “WWN1” is removed from the CA port 13 identified by “CA1 Port0” by the user, the linkdown detector 112 detects a linkdown from the host apparatus 20. Also, when the connected link of the host port 21 identified by “WWN2” is removed from the CA port 13 identified by “CA2 Port0” by the user, the linkdown detector 112 detects a linkdown from the host apparatus 20. Then, as illustrated in FIG. 17, the linkup detector 111 enters two pieces of the port information 104 indicated by “CA1 Port0” and “CA2 Port0” in the processing target CA port table 107.

The user inputs a deletion instruction into the deletion input processing unit 117 of the port information 104 and the host information 102 of the host ports 21 identified by “WWN1” and “WWN2”.

As illustrated in FIG. 15, the port information deletion unit 118 deletes the port information 104 indicated by “CA1 Port0” and “CA2 Port0” from the port group table 103 (see the broken line in FIG. 15). That is, as illustrated in FIG. 17, the port information deletion unit 118 deletes all the port information 104 from the port group table 103.

As illustrated in FIG. 15, the host information deletion unit 119 deletes the host information 102 indicated by “WWN1” and “WWN2” from the host group table 101 (see the broken line in FIG. 15). That is, as illustrated in FIG. 17, the host information deletion unit 119 deletes all the host information 102 from the host group table 101.

Because, as illustrated in FIG. 16, the linkdown detector 112 has detected linkdowns from all the CA ports 13, the logical volume information deletion unit 120 deletes the LUN group table 105. In other words, as illustrated in FIG. 17, the logical volume information deletion unit 120 deletes all the logical volume information 106 from the LUN group table 105.

Then, as illustrated in FIG. 17, the access processing table 100 is in a state in which no access processing group is entered.

[A-2] Operation

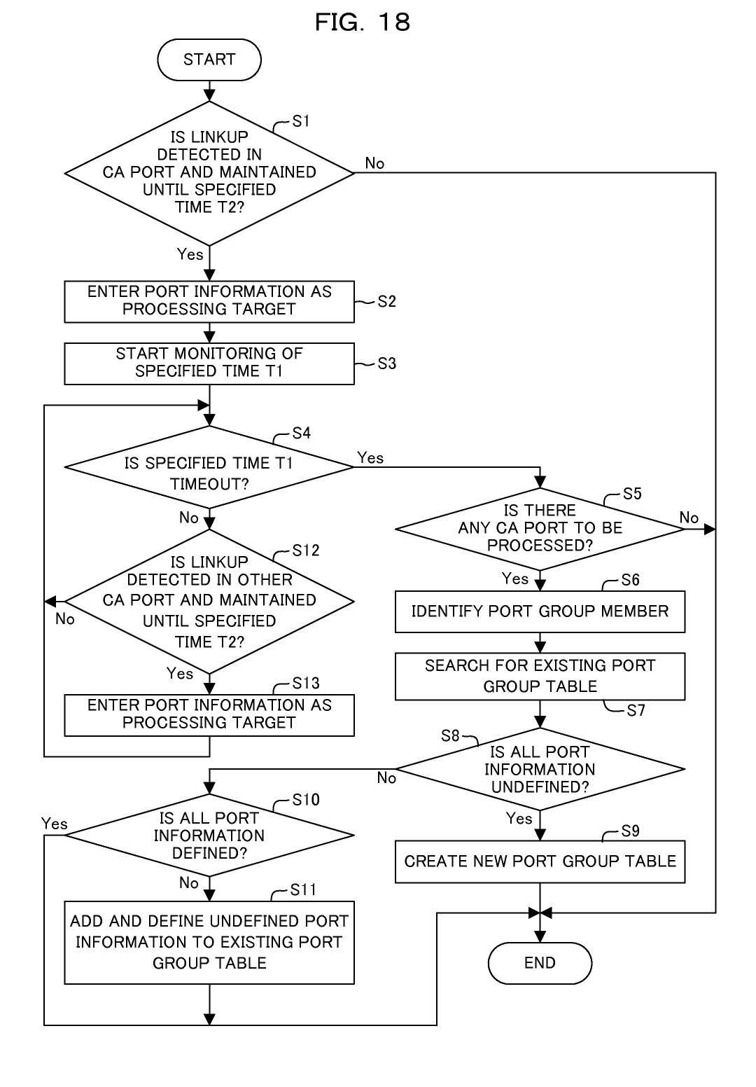

The creation processing of a port group table in CM as an example of the first embodiment configured as described above will be described according to the flow chart (steps S1 to S13) illustrated in FIG. 18.

The linkup detector 111 detects a linkup in the one CA port 13, and determines whether the linkup is maintained for the second specified time T2 or longer (step S1).

When no linkup is detected, or the linkup is not maintained for the second specified time T2 or longer (see No route in step S1), the processing terminates.

On the other hand, when a linkup is detected, and the linkup is maintained for the second specified time T2 or longer (see Yes route in step S1), the linkup detector 111 enters the port information 104 of the relevant CA port 13 in the processing target CA port table 107 (step S2).

The linkup detector 111 starts monitoring of the first specified time T1 (step S3).

The linkup detector 111 determines whether the first specified time T1 has timed-out (step S4).

When the first specified time T1 has timed-out (see Yes route in step S4), the port information generator 113 determines whether the port information 104 is entered in the processing target CA port table 107 (step S5).

When the port information 104 is not entered in the processing target CA port table 107 (see No route in step S5), the processing terminates.

On the other hand, when the port information 104 is entered in the processing target CA port table 107 (see Yes route in step S5), the port information generator 113 identifies the port information 104 entered in the processing target CA port table 107 as port group members intended for a setting operation (step S6).

The port information generator 113 searches for the existing port group table 103 in which the identified port group members are defined (step S7).

The port information generator 113 determines whether all the port information 104 as the port group members is undefined in the existing port group table 103 (step S8).

When all the port information 104 is undefined in the existing port group table 103 (see Yes route in step S8), the port information generator 113 newly creates the port group table 103 defining the identified port group members (step S9). Then, the processing terminates.

On the other hand, when some piece of the port information 104 is defined in the existing port group table 103 (see No route in step S8), the port information generator 113 determines whether all the port information 104 is defined in the existing port group table 103 (step S10).

When all the port information 104 is defined in the existing port group table 103 (see Yes route in step S10), the processing terminates.

On the other hand, when a portion of the port information 104 is undefined in the existing port group table 103 (see No route in step S10), the port information generator 113 additionally defines the undefined port information 104 in the existing port group table 103 (step S11). Then, the processing terminates.

In step S4, when the first specified time T1 has not timed-out (see No route in step S4), the linkup detector 111 determines whether a linkup is detected in the other CA port 13 than the CA port 13 where a linkup has been detected, and the linkup is maintained for the second specified time T2 or longer (step S12).

When no linkup is detected in the other CA ports 13, or the linkup is not maintained for the second specified time T2 or longer (see No route in step S12), the processing returns to step S4.

On the other hand, when a linkup is detected in the other CA port 13, and the linkup is maintained for the second specified time T2 or longer (see Yes route in step S12), the linkup detector 111 enters the port information 104 of the other CA port 13 that is newly detected in the processing target CA port table 107 (step S13). Then, the processing returns to step S4.

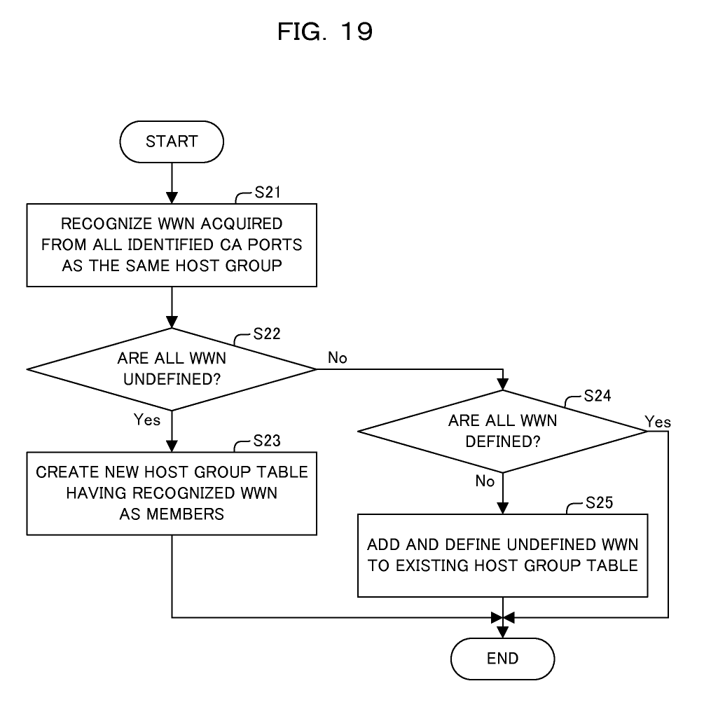

Next, the creation processing of a host group table in CM as an example of the first embodiment will be described according to the flow chart (steps S21 to S25) illustrated in FIG. 19.

The host information generator 114 recognizes WWN acquired from all the CA ports 13 identified by the port information generator 113 as the same host group (step S21).

The host information generator 114 determines whether all WWN belonging to the recognized host group are undefined in the existing host group table 101 (step S22).

When all WWN are undefined (see Yes route in step S22), the host information generator 114 newly creates the host group table 101 defining recognized WWN as a host group member (step S23), and then the processing terminates.

On the other hand, when some WWN is already defined in the existing host group table 101 (see No route in step S22), the host information generator 114 determines whether all WWN belonging to the recognized host group are already defined in the existing host group table 101 (step S24).

When all WWN are defined (see Yes route in step S24), the processing terminates.

On the other hand, when a portion of WWN is undefined (see No route in step S24), the host information generator 114 additionally defines undefined WWN in the existing host group table 101 (step S25), and the processing terminates.

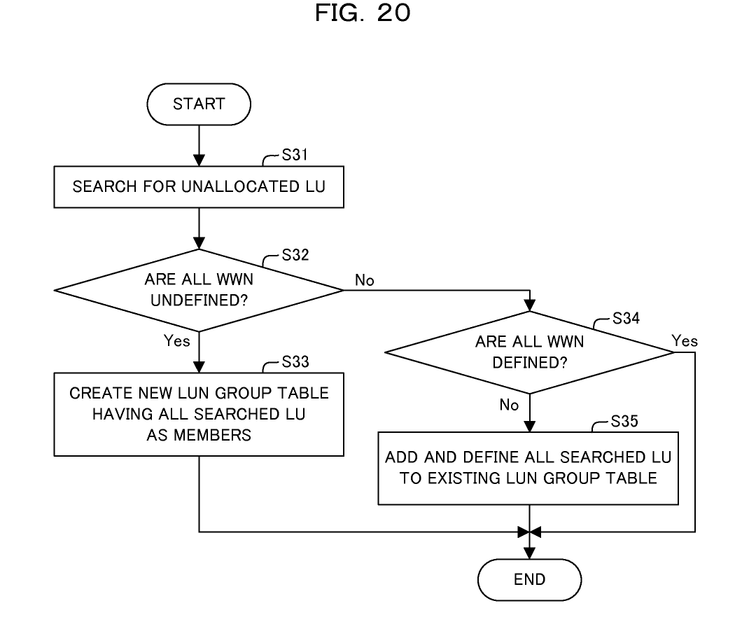

Next, the creation processing of a LUN group table in CM as an example of the first embodiment will be described according to the flow chart (steps S31 to S35) illustrated in FIG. 20.

The logical volume information generator 115 searches for unallocated LU that is not associated with any host group (step S31).

The logical volume information generator 115 determines whether all WWN belonging to host group recognized by the host information generator 114 are undefined in the existing host group table 101 (step S32).

If all WWN are undefined (see Yes route in step S32), the logical volume information generator 115 newly creates the LUN group table 105 defining all searched LU as LUN group members (step S33) and the processing terminates.

On the other hand, if some WWN is already defined in the existing host group table 101 (see No route in step S32), the logical volume information generator 115 determines whether all WWN belonging to the host group recognized by the host information generator 114 are already defined in the existing host group table 101 (step S34).

When all WWN are already defined (see Yes route in step S34), the processing terminates.

On the other hand, when a portion of WWN is undefined (see No route in step S34), the logical volume information generator 115 additionally defines all searched LU in the existing LUN group table 105 (step S35), and the processing terminates.

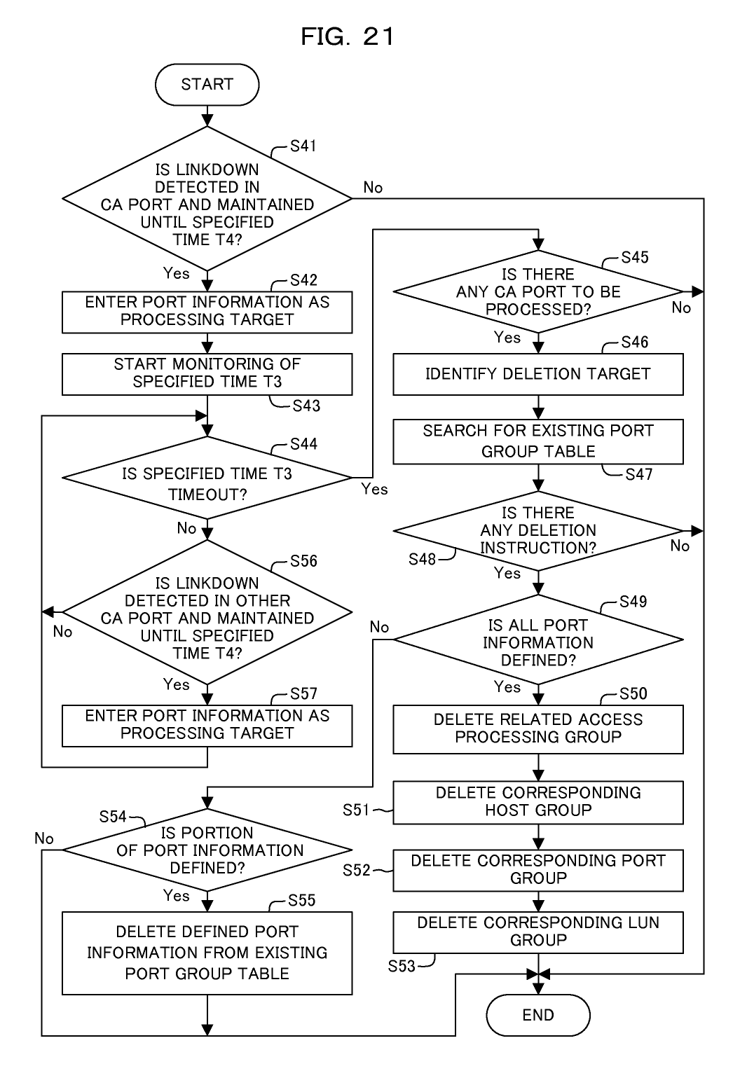

Next, the deletion processing of an access processing table in CM as an example of the first embodiment will be described according to the flow chart (steps S41 to S57) illustrated in FIG. 21.

The linkdown detector 112 determines whether a linkup is detected in the one CA port 13, and the linkup is maintained for the fourth specified time T4 or longer (step S41).

When no linkup is detected, or the linkup is not maintained for the fourth specified time T4 or longer (see No route in step S41), the processing terminates.

On the other hand, when a linkup is detected, and the linkup is maintained for the fourth specified time T4 or longer (see Yes route in step S41), the linkup detector 111 enters the port information 104 of the relevant CA port 13 in the processing target CA port table 107 (step S42).

The linkup detector 111 starts monitoring of the third specified time T3 (step S43).

The linkup detector 111 determines whether the third specified time T3 has timed-out (step S44)

When the third specified time T3 has timed-out (see Yes route in step S44), the port information deletion unit 118 determines whether the port information 104 is entered in the processing target CA port table 107 (step S45).

When the port information 104 is not entered in the processing target CA port table 107 (see No route in step S45), the processing terminates.

On the other hand, when the port information 104 is entered in the processing target CA port table 107 (see Yes route in step S45), the port information deletion unit 118 identifies the port information 104 is entered in the processing target CA port table 107 as a deletion target (step S46).

The port information deletion unit 118 searches for the existing port group table 103 in which the identified port information 104 is defined (step S47).

The deletion input processing unit 117 determines whether deletion instruction is input by the user via, for example, MMI of a control terminal (not illustrated) included in the storage system 1 (step S48).

When no deletion instruction is input (see No route in step S48), the processing terminates.

On the other hand, when a deletion instruction is input (see Yes route in step S48), the port information deletion unit 118 determines whether all the identified port information 104 is already defined in the existing port group table 103 (step S49).

When all the port information 104 is defined (see Yes route in step S49), the port information deletion unit 118 deletes the access processing group associated with the identified port information 104 from the access processing table 100 (step S50).

The host information deletion unit 119 deletes the host group corresponding to the deleted access processing group from the host group table 101 (step S51).

The port information deletion unit 118 deletes the port group corresponding to the deleted access processing group from the port group table 103 (step S52).

The logical volume information deletion unit 120 deletes the LUN group corresponding to the deleted access processing group from the LUN group table 105 (step S53), and the processing terminates.

In step S49, when any piece of the port information 104 is undefined in the existing port group table 103 (see No route in step S49), the port information deletion unit 118 determines whether a portion of the port information 104 is already defined in the existing port group table 103 (step S54).

When all the port information 104 is undefined in the existing port group table 103 (see No route in step S54), the processing terminates.

On the other hand, when a portion of the port information 104 is already defined in the existing port group table 103 (see Yes route in step S54), the port information deletion unit 118 deletes the defined port information 104 from the existing port group table 103 (step S55), and the processing terminates.

In step S44, when the third specified time T3 has not timed-out (see No route in step S44), the linkdown detector 112 determines whether a linkdown is detected in the other CA port 13 than the CA port 13 where a linkdown has been detected, and the linkdown is maintained for the fourth specified time T4 or longer (step S56).

When no linkdown is detected in the other CA ports 13, or the linkdown is not maintained for the fourth specified time T4 or longer (see No route in step S56), the processing returns to step S44.

On the other hand, when a linkdown is detected in the other CA port 13, and the linkdown is maintained for the fourth specified time T4 or longer (see Yes route in step S56), the linkdown detector 112 enters the port information 104 of the other CA port 13 that is newly detected in the processing target CA port table 107 (step S57). Then, the processing returns to step S44.

[A-3] Effect

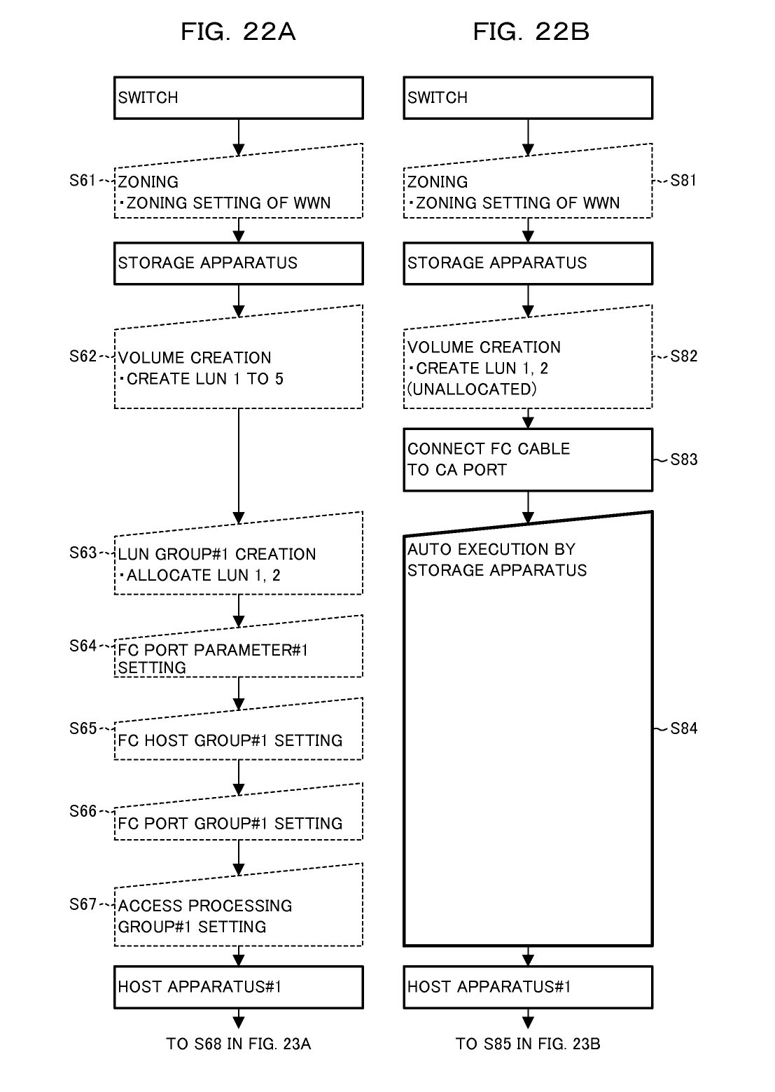

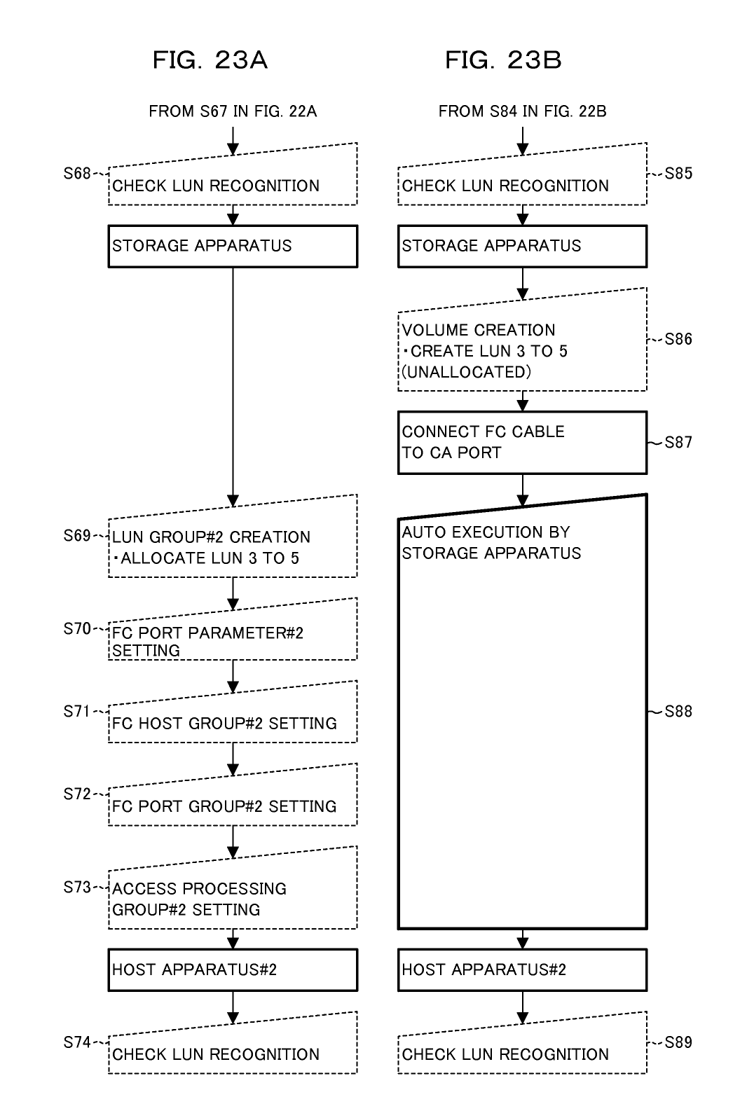

FIGS. 22A and 23A are flow charts illustrating the connection control processing in a storage system as a related technology of the first embodiment, and FIGS. 22B and 23B are flow charts illustrating the connection control processing in a storage system as an example of the first embodiment.

Hereinafter, effects that can be achieved by the CM (connection control apparatus) 11 in an example of the first embodiment described above will be described with reference to the flow charts (steps S61 to S74, S81 to S89) illustrated in FIGS. 22A to 23B.

FIG. 22A illustrates processing of steps S61 to S67, FIG. 23A illustrates processing of steps S68 to S74, FIG. 22B illustrates processing of steps S81 to S84, and FIG. 23B illustrates processing of steps S85 to S89.

First, the connection control processing in a storage system performed manually by the user as a related technology of the first embodiment will be described and then, the connection control processing in a storage system as an example of the first embodiment will be described.

The user makes zoning settings of WWN for the switch (FC switch) (step S61 in FIG. 22A).

The user performs an operation to create logical volumes LUN1 to LUN5 on the storage apparatus (storage array apparatus) (step S62 in FIG. 22A).

The user performs an operation to create a LUN group#1 on the storage apparatus to allocate LUN1 and LUN2 to the LUN group#1 (step S63 in FIG. 22A).

The user performs an operation to set an FC port parameter#1 on the storage apparatus (step S64 in FIG. 22A).

The user performs an operation to set an FC host group#1 on the storage apparatus (step S65 in FIG. 22A).

The user performs an operation to set an FC port group#1 on the storage apparatus (step S66 in FIG. 22A).

The user performs an operation to set an access processing group#1 on the storage apparatus (step S67 in FIG. 22A).

The user checks whether the host apparatus#1 recognizes LUN (step S68 in FIG. 23A).

The user performs an operation to create a LUN group#2 on the storage apparatus to allocate LUN3 to LUN5 to the LUN group#2 (step S69 in FIG. 23A).

The user performs an operation to set an FC port parameter#2 on the storage apparatus (step S70 in FIG. 23A).

The user performs an operation to set an FC host group#2 on the storage apparatus (step S71 in FIG. 23A).

The user performs an operation to set an FC port group#2 on the storage apparatus (step S72 in FIG. 23A).

The user performs an operation to set an access processing group#2 on the storage apparatus (step S73 in FIG. 23A).

The user checks whether the host apparatus#2 recognizes LUN (step S74 in FIG. 23A).

Next, the connection control processing in a storage system as an example of the first embodiment will be described.

The user makes zoning settings of WWN for the switch (FC switch) 30 (step S81 in FIG. 22B).

The user performs an operation to create logical volumes LUN1 and LUN2 on the storage apparatus (RAID apparatus) 10 (step S82 in FIG. 22B). Here, LUN1 and LUN2 are made unallocated to the host apparatus 20.

The user connects an FC cable (link) to the CA port 13 (step S83 in FIG. 22B).

The storage apparatus 10 automatically performs the connection control processing (step S84 in FIG. 22B).

The user checks whether the host apparatus#1 (host apparatus 20) recognizes LUN (step S85 in FIG. 23B).

The user performs an operation to create logical volumes LUN3 to LUN5 on the storage apparatus 10 (step S86 in FIG. 23B). Here, LUN3 to LUN5 are made unallocated to the host apparatus 20.

The user connects the FC cable to the CA port 13 (step S87 in FIG. 23B).

The storage apparatus 10 automatically performs the connection control processing (step S88 in FIG. 23B).

The user checks whether the host apparatus#2 (host apparatus 20) recognizes LUN (step S89 in FIG. 23B).

Thus, the processing “LUN group creation”, “FC port parameter setting”, “FC host group setting”, “FC port group setting”, and “access processing group setting” (steps S63 to S67 in FIG. 22A and steps S69 to S73 in FIG. 23A) performed manually by the user as the related technology of the first embodiment is automatically performed by the storage apparatus 10 in an example of the first embodiment (step S84 in FIG. 22B and step S88 in FIG. 23B).

Accordingly, the procedure for recognition of logical volumes by the host apparatus 20 can be simplified.

According to the CM (connection control apparatus) 11 in an example of the first embodiment described above, for example, the following operation effects can be achieved.

The port information generator 113 generates the port group table 103 containing the port information 104 to identify the CA port 13 where a linkup is detected by the linkup detector 111. The host information generator 114 generates the host group table 101 containing the host information 102 to identify the host port 21 where a linkup is detected by the linkup detector 111. Further, the logical volume information generator 115 generates the LUN group table 105 containing the logical volume information 106 to identify the logical volume of all unallocated logical volumes. Then, the access processing information generator 116 generates the access processing table 100 associating the port group table 103, the host group table 101, and the LUN group table 105.

Accordingly, only by connecting a link to the CA port 13, the storage apparatus 10 is automatically set, and LUN can be recognized from the host apparatus 20, reducing the time and effort of the setting operation by the user.

When predetermined conditions are satisfied, the port information generator 113 enters the port information 104 of each of the plurality of host ports 21 in the port group table 103 as the same group. Also, when predetermined conditions are satisfied, the host information generator 114 enters the host information 102 of each of the plurality of host ports 21 in the host group table 101 as the same group.

Accordingly, the same logical volume can be shared by a plurality of the host apparatuses 20. Also, the host apparatus 20 that can access a logical volume can be defined, and security when the plurality of host apparatuses 20 is connected can be guaranteed. Further, the accessible logical volume can be set for each of the host ports 21.

When predetermined conditions are satisfied, the port information generator 113 enters, in addition to the port information 104 of the acquired host port 21, the port information 104 of the host port 21 newly linked up in the port group table 103 as the same group. Also, when predetermined conditions are satisfied, the host information generator 114 enters, in addition to the host information 102 of the acquired host port 21, the host information 102 of the host port 21 newly linked up in the host group table 101 as the same group.

Accordingly, the logical volume already allocated to the host apparatus 20 can additionally be allocated to the other host apparatus 20.

When predetermined conditions are satisfied, the logical volume information generator 115 enters, in addition to the acquired logical volume information 106, the logical volume information 106 of all unallocated logical volumes newly added in the LUN group table 105 as the same group.

Accordingly, a logical volume can additionally be allocated to the host apparatus 20 to which a logical volume is already allocated.

When an input into the deletion input processing unit 117 arises, the port information deletion unit 118 deletes the port information 104 of the host port 21 where the linkdown detector 112 detects a linkdown from the port group table 103. Also, when an input into the deletion input processing unit 117 arises, the host information deletion unit 119 deletes the host information 102 of the host port 21 where the linkdown detector 112 detects a linkdown from the host group table 101. Further, when an input into the deletion input processing unit 117 arises and the linkdown detector 112 detects linkdowns from all the host ports 21 connected to the storage apparatus 10, the logical volume information deletion unit 120 deletes the logical volume group table 105.

Accordingly, only by removing the link from the CA port 13 and inputting a deletion instruction, the storage apparatus 10 is automatically set, and LUN is released from the host apparatus 20 so that the time and effort of the setting operation by the user can be reduced. In addition, the execution of deletion processing assumes the input of a deletion instruction as a condition and therefore, the deletion of settings of the storage apparatus 10 due to a user's operation error or unexpected power-off can be prevented.

### [B] Example of Second Embodiment

[B-1] System Configuration

When the protocol between the storage apparatus 10 and the host apparatus 20 is Internet Small Computer System Interface (iSCSI), the CM 11 as an example of the second embodiment makes connection settings of iSCSI.

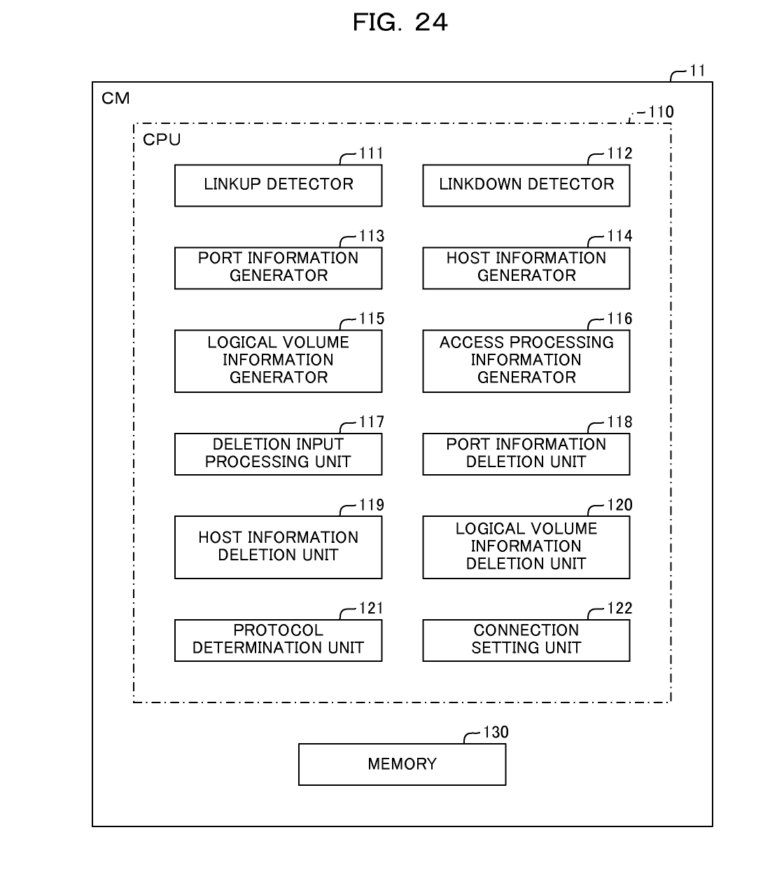

FIG. 24 is a diagram schematically illustrating the function configuration of CM as an example of the second embodiment.

Hereinafter, the same reference sign in diagrams indicates a similar portion and the description thereof is omitted.

The CPU 110 in the CM 11 as an example of the second embodiment, in addition to the function of the CPU 110 in the CM 11 as an example of the first embodiment illustrated in FIG. 2, further functions as a protocol determination unit 121 and a connection setting unit 122 illustrated in FIG. 24.

The protocol determination unit 121 determines the protocol between the storage apparatus 10 and the host apparatus 20. The protocol between the storage apparatus 10 and the host apparatus 20 is, for example, FC, FCoE, SAS, or iSCSI. For example, the protocol determination unit 121 determines whether the protocol between the storage apparatus 10 and the host apparatus 20 is iSCSI. The protocol determination unit 121 determines the protocol when a linkup between the CA port 13 and the host port 21 is maintained for the second specified time T2 or longer. Also, the protocol determination unit 121 determines the protocol when a linkdown occurs between the CA port 13 and the host port 21.

The connection setting unit 122 makes connection settings of iSCSI when the protocol determination unit 121 determines that the protocol between the storage apparatus 10 and the host apparatus 20 is iSCSI. More specifically, the connection setting unit 122 creates management information associating identification information to identify the host apparatus 20 (host port 21) and target information to the CA port 13. Then, the connection setting unit 122 creates a command based on the created management information, and executes the created command to make connection settings to the host apparatus 20.

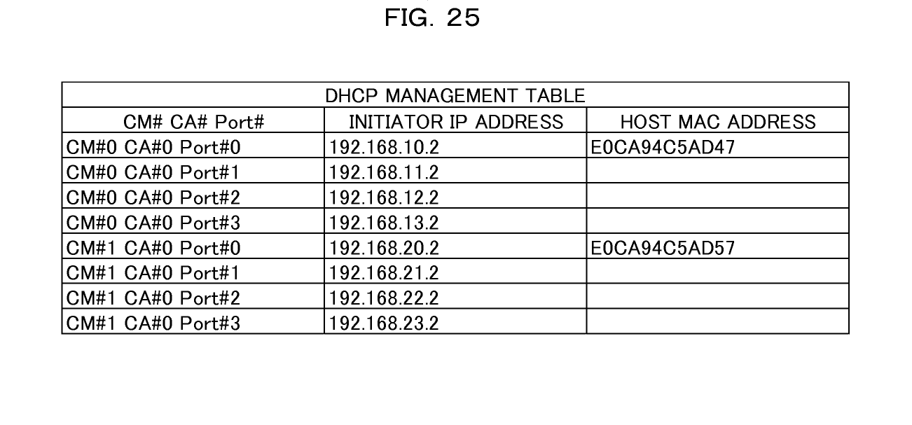

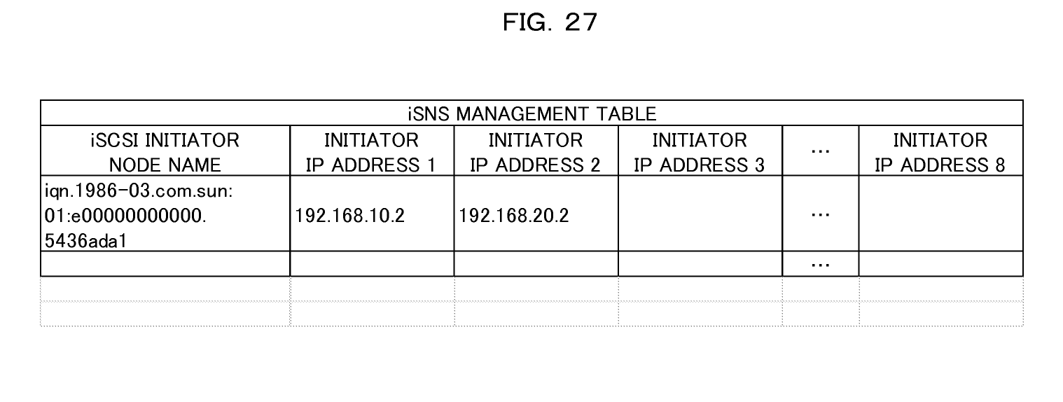

The identification information is information containing an initiator IP address (described below using FIGS. 25, 27, and 28), a host MAC address (described below using FIG. 25), and an iSCSI initiator node name (described below using FIG. 27).

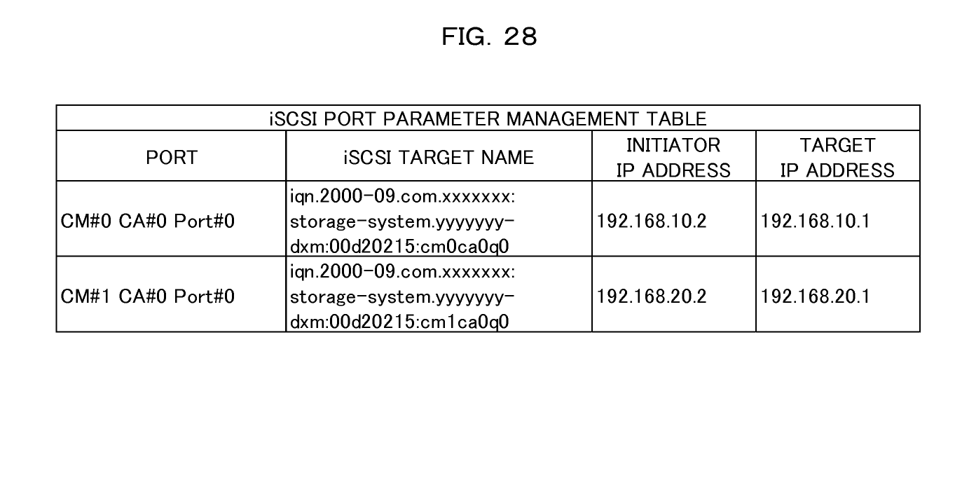

The target information is information containing an iSCSI target name (described below using FIG. 28) and a target IP address (described below using FIG. 28).

The management information is information containing Dynamic Host Configuration Protocol (DHCP) management information (described below using FIG. 25), Internet Storage Name Service (iSNS) management information (described below using FIG. 27), and iSCSI port parameter management information (described below using FIG. 28).

The DHCP management information is information that associates the initiator IP address and the MAC address of the host port 21 for each of the CA ports 13 of the linkup destination. The DHCP management information is stored in, for example, the memory 130.

FIG. 25 is a diagram illustrating a DHCP management table in CM as an example of the second embodiment.

The DHCP management table represents DHCP management information in tabular form. The DHCP management table contains CM#, CA#, Port#, the initiator IP address, and the host MAC address as items.

CM#, CA#, and Port# are information to identify the CA port 13 of the storage apparatus 10. For example, “CM#0 CA#0 Port#0” or “CM#1 CA#0 Port#1” is entered in CM#, CA#, and Port#.

The initiator IP address represents an IP address allocated to the host port 21 linked up with each of the CA ports 13. For example, “192.168.10.2” or “192.168.20.2” is entered in the initiator IP address.

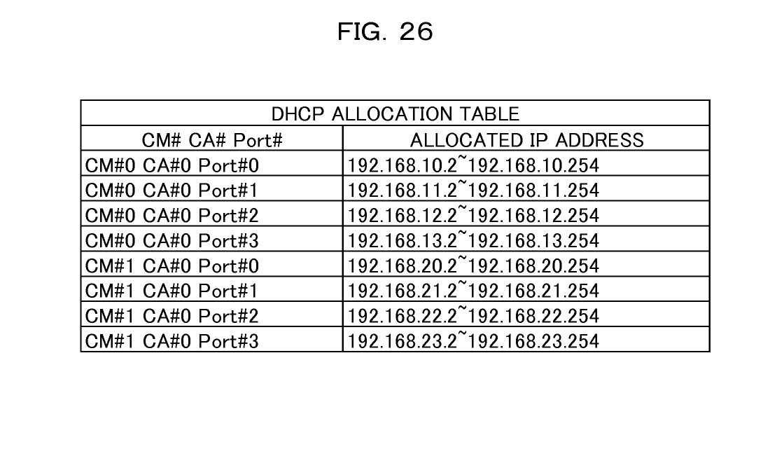

The connection setting unit 122 allocates the initiator IP address based on DHCP allocation information described below using FIG. 26.

The host MAC address is information to uniquely identify the host port 21 linked up with the CA port 13. For example, “E0CA94C5AD47” or “E0CA94C5AD57” is entered in the host MAC address.

When the storage apparatus 10 and the host apparatus 20 are linked up, the connection setting unit 122 receives a host MAC address sent from the host apparatus 20, and searches for DHCP management information using the received host MAC address as a key. When the received host MAC address is not entered in the DHCP management information, the connection setting unit 122 has the initiator IP address for the host MAC address allocated by a DHCP server 15. On the other hand, when the received host MAC address is entered in the DHCP management information, the connection setting unit 122 reallocates the initiator IP address entered in the DHCP management information for the host MAC address. This is because the initiator IP address is already allocated for the host MAC address, and the initiator IP address is entered in the DHCP management information.

When a linkdown occurs between the storage apparatus 10 and the host apparatus 20, the connection setting unit 122 deletes the host MAC address entered in the DHCP management information.

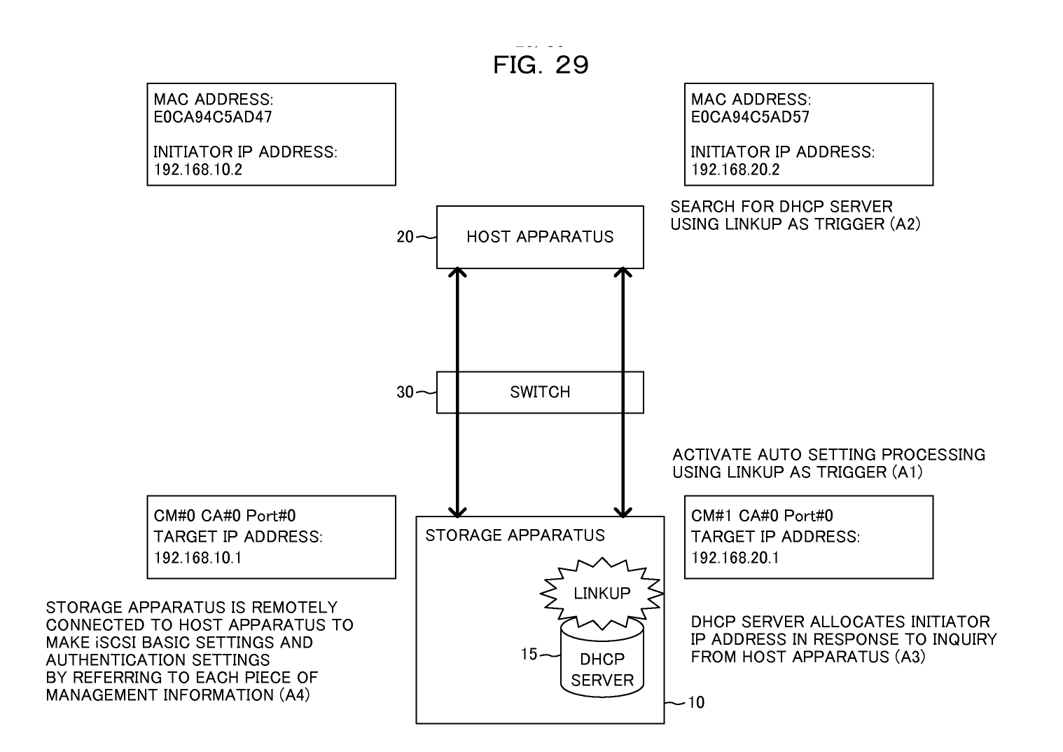

The DHCP allocation information indicates the range of the initiator IP address allocated to the linked-up host port 21 for each of the CA ports 13. The DHCP allocation information is stored in the DHCP server 15 (described below using FIG. 29) provided for each of the CA ports 13.

FIG. 26 is a diagram illustrating a DHCP allocation table in CM as an example of the second embodiment.

The DHCP allocation table illustrated in FIG. 26 is a representation of DHCP allocation information in tabular form. The DHCP allocation table contains CM#, CA#, Port#, and an allocated IP address as items.

CM#, CA#, and Port# are information to identify the port 13 of the storage apparatus 10. For example, “CM#0 CA#0 Port#0” or “CM#1 CA#0 Port#0” is entered in CM#, CA#, and Port#.

The allocated IP address indicates the range of the IP address that can be allocated to the host port 21 linked up with each of the CA ports 13. For example, “192.168.10.2 to 192.168.10.254” or “192.168.20.2 to 192.168.20.254” is entered in the allocated IP address.

In FIG. 26, for example, the table illustrates that initiator IP addresses of “192.168.10.2 to 192.168.10.254” can be allocated to the host port 21 linked up with the port#0 included in CA#0 of CM#0. Also, the table illustrates that initiator IP addresses of “192.168.20.2 to 192.168.20.254” can be allocated to the host port 21 linked up with the port#0 included in CA#0 of CM#1.

The iSNS management information is information to group and manage the one or the plurality of host ports 21 linked up within the second specified time T2 using the iSCSI initiator node name as a key. The iSNS management information is stored in, for example, the memory 130.

FIG. 27 is a diagram illustrating an iSNS management table in CM as an example of the second embodiment.

The iSNS management table illustrated in FIG. 27 represents iSNS management information in tabular form. The iSNS management table contains an iSCSI initiator node name and initiator IP addresses 1 to 8 as items.

The iSCSI initiator node name is the name to identify the group of the host ports 21 linked up within the second specified time. For example, “ipn.1986-03.com.sun:01:e00000000000.5436ada1” is entered as the iSCSI initiator node name.

The connection setting unit 122 acquires the iSCSI initiator node name from the host apparatus 20, and enters the acquired iSCSI initiator node name in iSNS management information.

The initiator IP addresses 1 to 8 indicate the host ports 21 linked up with the storage apparatus 10. The connection setting unit 122 enters the initiator IP address of the linked-up host port 21 by referring to the DHCP management information as the initiator IP address 1 to 8. For example, “192.168.10.2” or “192.168.20.2” is entered as the initiator IP address 1 to 8.

FIG. 27 illustrates an example in which the initiator IP address “192.168.10.2” and the initiator IP address “192.168.20.2” are linked up within the second specified time T2, and grouped under the iSCSI initiator node name “ipn.1986-03.com.sun:01:e00000000000.5436ada1”.

The iSCSI port parameter management information is information to associate and manage the iSCSI target name, initiator IP address, and target IP address for each of the linked-up ports 13 of the storage apparatus 10.

FIG. 28 is a diagram illustrating an iSCSI port parameter management table in CM as an example of the second embodiment.

The iSCSI port parameter management table illustrated in FIG. 28 represents iSCSI port parameter management information in tabular form. The iSCSI port parameter management table contains the port, iSCSI target name, initiator IP address, and target IP address as items.

The port is information to identify the linked-up CA port 13. For example, “CM#0 CA#0 Port#0” or “CM#1 CA#0 Port#0” is entered as the port.

The iSCSI target name is a name to identify the linked-up CA port 13. For example, “iqn.2000-09.com.xxxxxxx-storage-system.yyyyyyy-dxm:00d20215:cm0ca0q0” or “iqn.2000-09.com.xxxxxxx-storage-system.yyyyyyy-dxm:00d20215:cm1ca0q0” is entered as the iSCSI target name.

The connection setting unit 122 acquires the iSCSI target name corresponding to the linked-up CA port 13 from, for example, the memory 130, and enters the acquired iSCSI target name in the iSCSI port parameter information.

The initiator IP address indicates an IP address allocated to the host port 21 linked up with each of the CA ports 13. For example, “192.168.10.2” or “192.168.20.2” is entered as the initiator IP address.

The connection setting unit 122 enters the initiator IP address in the iSCSI port parameter information based on the DHCP management information and the iSNS management information described using FIGS. 25 and 27 respectively, and associates with the linked-up host port 21.

The target IP address indicates an IP address allocated to the CA port 13 linked-up with each of the host ports 21. For example, “192.168.10.1” or “192.168.20.1” is entered in the target IP address.

The connection setting unit 122 enters the target IP address fixed for each of the CA ports 13 in the iSCSI port parameter information.

The connection setting unit 122 makes iSCSI basic settings. In the iSCSI basic settings, the connection setting unit 122 generates a plurality of commands, and executes the generated commands. The connection setting unit 122 performs, for example, setting processing to connect to an iSCSI target. More specifically, the connection setting unit 122 acquires the target IP address from iSCSI port parameter information, generates a command to connect to the iSCSI target, and executes the generated command in the host apparatus 20. The connection setting unit 122 generates, for example, “# iscsiadm add discovery-address 192.168.10.1” as a command to connect to the iSCSI target.

The connection setting unit 122 also makes settings for the target to authenticate the initiator. In the settings for the target to authenticate the initiator, the connection setting unit 122 generates a plurality of commands and executes the generated commands. The connection setting unit 122 performs, for example, enable processing of Challenge-Handshake Authentication Protocol (CHAP). More specifically, the connection setting unit 122 acquires the iSCSI target name from iSCSI port parameter information using the target IP address as a key, generates a command to enable CHAP, and executes the generated command. The connection setting unit 122 creates, for example, “# iscsiadm modify initiator-node-authentication CHAP” and “# iscsiadm modify target-param-a CHAP iqn.2000-09.com.xxxxxxx:storage-system.yyyyyyy-dxm:00d20215:cm0ca0p0” as commands to enable CHAP.

Further, the connection setting unit 122 makes settings for the initiator to authenticate the target. In the settings for the initiator to authenticate the target, the connection setting unit 122 generates a plurality of commands and executes the generated commands. The connection setting unit 122 performs, for example, CHAP authentication setting processing. More specifically, the connection setting unit 122 acquires the iSCSI target name from iSCSI port parameter information using the target IP address as a key, generates a command to set the CHAP authentication of the target, and executes the generated command. The connection setting unit 122 creates, for example, “# iscsiadm modify target-param-authentication CHAP iqn.2000-09.com.xxxxxxx:storage-system.yyyyyyy-dxm:00d20215:cm0ca0p0” and “# iscsiadm modify target-param-authentication CHAP iqn.2000-09.com.xxxxxxx:storage-system.yyyyyyy-dxm:00d20215:cm0ca0p0” as commands to set the CHAP authentication of the target.

[B-2] Operation

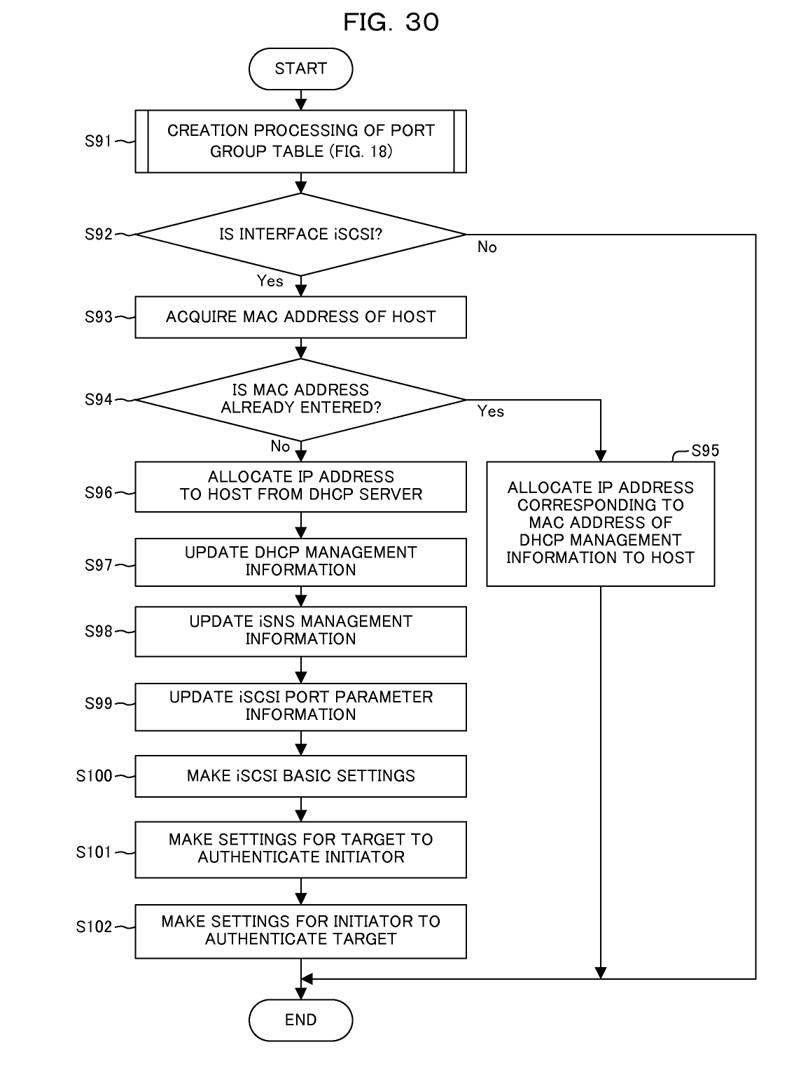

The connection setting processing in CM as an example of the second embodiment configured as described above will be described with reference to FIG. 29, according to the flow chart (steps S91 to S102) illustrated in FIG. 30.

FIG. 29 is a diagram illustrating the connection setting processing in CM as an example of the second embodiment.

The storage apparatus 10 includes, as illustrated in FIG. 29, the DHCP server 15. As described above using FIG. 26, the DHCP server 15 is included in each of the CA ports 13, and stores the allocated IP address corresponding to each of the CA ports 13 as DHCP allocation information.

In the example illustrated in FIG. 29, the port#0 included in CA#0 of CM#0 identified by the target IP address “192.168.10.1” is linked up with the host port 21 identified by the MAC address “E0CA94C5AD47” and the initiator IP address “192.168.10.2”.

Also, the port#0 included in CA#0 of CM#1 identified by the target IP address “192.168.20.1” is linked up with the host port 21 identified by the MAC address “E0CA94C5AD57” and the initiator IP address “192.168.20.2”.

First, the CPU 110 performs the creation processing of a port group table described above using FIG. 18 (step S91 in FIG. 30).

The protocol determination unit 121 determines whether the interface between the storage apparatus 10 and the host apparatus 20 is iSCSI (step S92 in FIG. 30).

When the interface is not iSCSI (see No route in step S92 in FIG. 30), the processing terminates.

On the other hand, when the interface is iSCSI (see Yes route in step S92 in FIG. 30), the connection setting unit 122 starts automatic setting processing using a linkup as a trigger (reference sign Al in FIG. 29), and acquires the MAC address of the host apparatus 20 (step S93 in FIG. 30).

The connection setting unit 122 determines whether the saved MAC address is already entered in the DHCP management information (step S94 in FIG. 30).

When the MAC address is already entered (see Yes route in step S94 in FIG. 30), the connection setting unit 122 allocates the initiator IP address associated with the MAC address entered in the DHCP management information to the linked-up host port 21 (step S95 in FIG. 30). Then, the processing terminates.

On the other hand, if the MAC address is not entered (see No route in step S94 in FIG. 30), the host apparatus 20 searches for the DHCP server 15 (reference sign A2 in FIG. 29). Then, the connection setting unit 122 allocates an initiator IP address entered on the DHCP server 15 to the host port 21 (step S96 in FIG. 30). In other words, in response to an inquiry from the host apparatus 20, the DHCP server 15 allocates the initiator IP address (reference sign A3 in FIG. 29).

The connection setting unit 122 updates the DHCP management information (step S97 in FIG. 30).

The connection setting unit 122 updates the iSNS management information (step S98 in FIG. 30).

The connection setting unit 122 updates the iSCSI port parameter information (step S99 in FIG. 30).

The connection setting unit 122 makes iSCSI basic settings (step S100 in FIG. 30).

The connection setting unit 122 makes settings for the target to authenticate the initiator (step S101 in FIG. 30).

The connection setting unit 122 makes settings for the initiator to authenticate the target (step S102 in FIG. 30), and the processing terminates.

That is, the storage apparatus 10 is remotely connected to the host apparatus 20 to make iSCSI basic settings and authentication settings (reference sign A4 in FIG. 29) by referring to the DHCP management information, iSNS management information and iSCSI port parameter information, and the processing terminates.

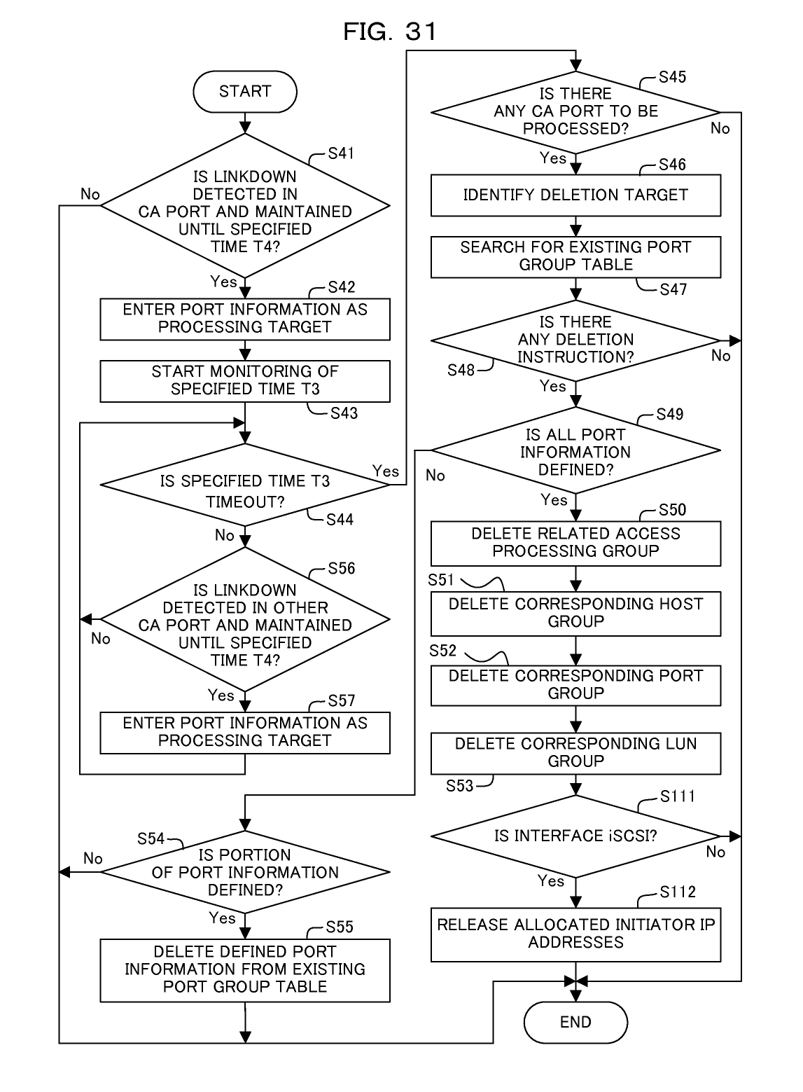

Next, disconnection setting processing in CM as an example of the second embodiment will be described according to the flow chart (steps S41 to S57, S111, and S112) illustrated in FIG. 31.

The processing illustrated in steps S41 to S57 in FIG. 31 is the same as the processing illustrated in steps S41 to S57 in FIG. 21, and the description thereof is omitted.

In step S53, the logical volume information deletion unit 120 deletes the LUN group corresponding to the deleted access processing group from the LUN group table 105.

Then, the protocol determination unit 121 determines whether the interface between the storage apparatus 10 and the host apparatus 20 is iSCSI (step S111).

When the interface is not iSCSI (see No route in step S111), the processing terminates.

On the other hand, when the interface is iSCSI (see Yes route in step S111), the connection setting unit 122 releases the initiator IP address allocated to the host port 21 in the DHCP management information (step S112), and the processing terminates.

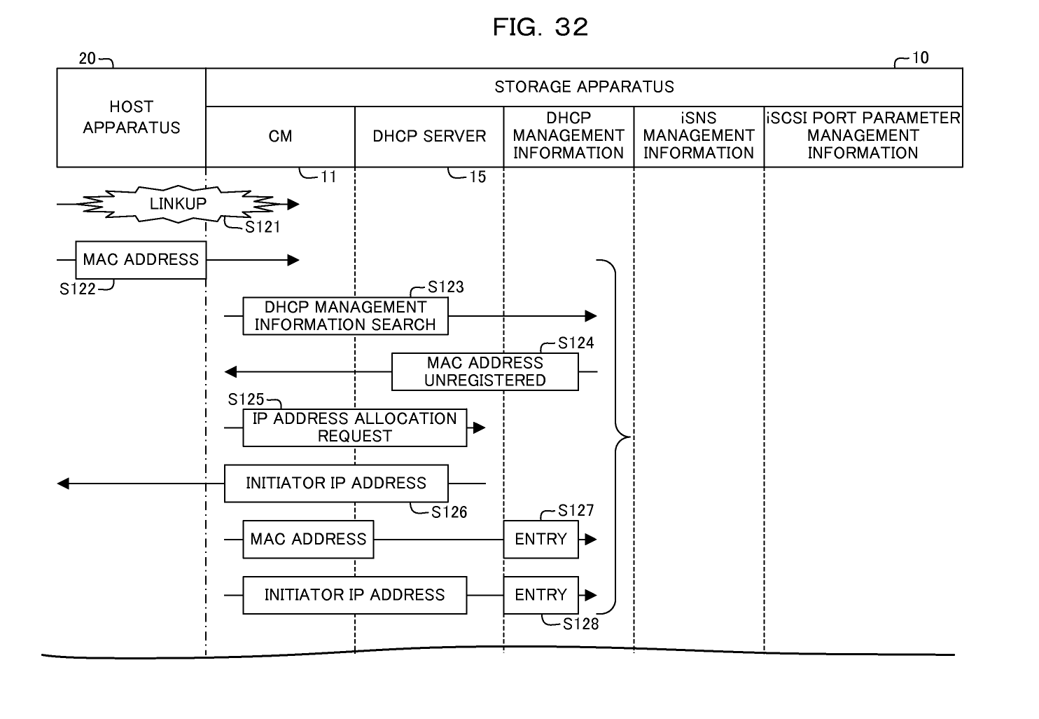

Next, new connection setting processing in CM as an example of the second embodiment will be described according to a sequence diagram (steps S121 to S138) illustrated in FIGS. 32 to 34.

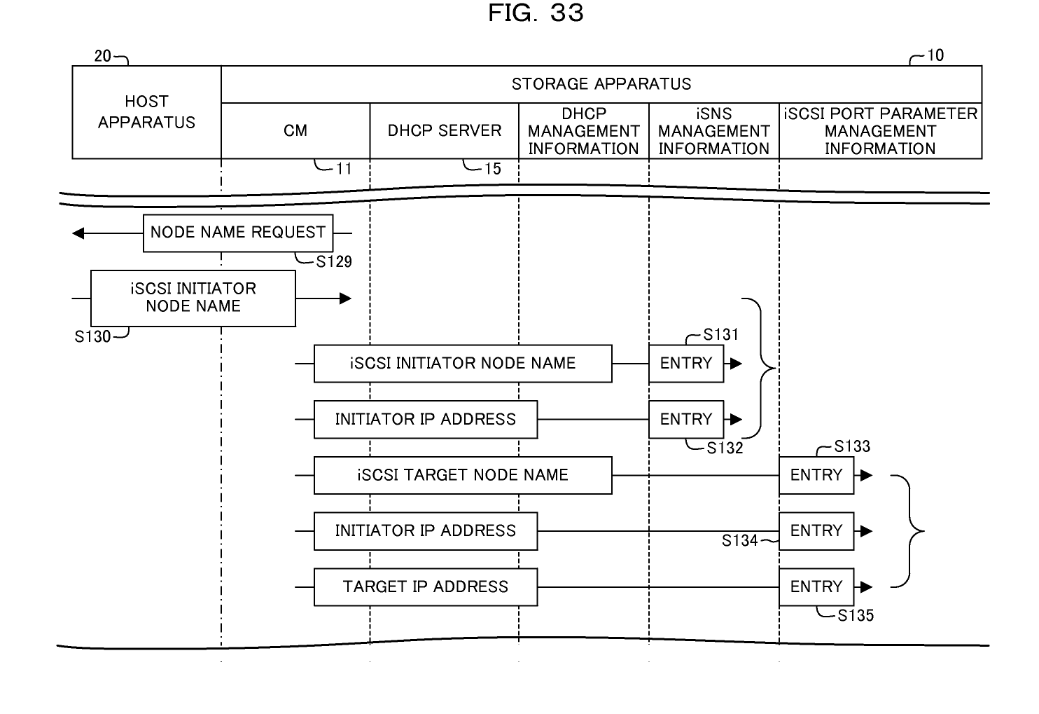

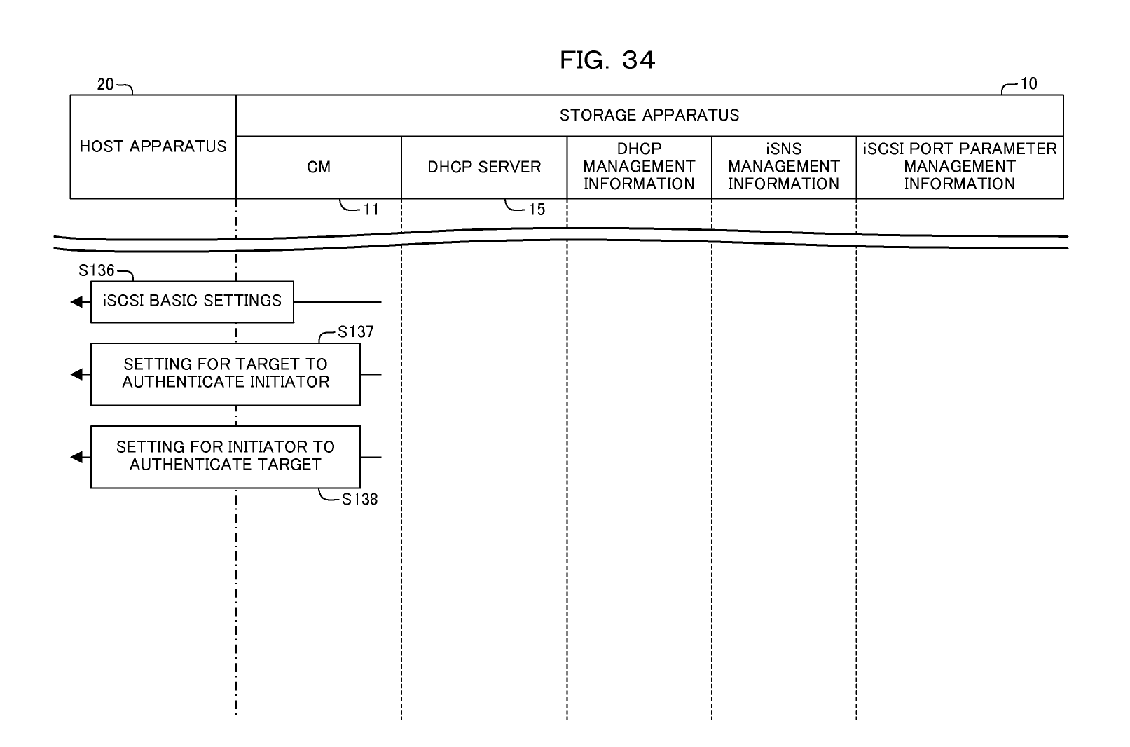

FIG. 32 illustrates processing of steps S121 to S128, FIG. 33 illustrates processing of steps S129 to S135, and FIG. 34 illustrates processing of steps S136 to S138.

The linkup detector 111 detects a linkup of the storage apparatus 10 and the host apparatus 20, and the CM 11 performs connection control processing (step S121 in FIG. 32).

The connection setting unit 122 of the CM 11 acquires the MAC address of the host port 21 from the host apparatus 20 (step S122 in FIG. 32).

The connection setting unit 122 searches for DHCP management information (step S123 in FIG. 32).

In the example illustrated in FIG. 32, the connection setting unit 122 recognizes that the MAC address acquired from the host apparatus 20 is not entered in the DHCP management table (step S124 in FIG. 32).

The connection setting unit 122 makes a request to the DHCP server 15 for the allocation of an initiator IP address to the host port 21 (step S125 in FIG. 32).

The DHCP server 15 allocates an initiator IP address to the host port 21 by referring to DHCP allocation information (step S126 in FIG. 32).

The connection setting unit 122 enters the MAC address acquired from the host apparatus 20 in the DHCP management information (step S127 in FIG. 32).

The connection setting unit 122 enters the initiator IP address allocated to the host port 21 by the DHCP server 15 in the DHCP management information (step S128 in FIG. 32).

The connection setting unit 122 requests the notification of an iSCSI initiator node name from the host apparatus 20 (step S129 in FIG. 33).

The host apparatus 20 provides notification (response) of the iSCSI initiator node name to the CM 11 (step S130 in FIG. 33).

The connection setting unit 122 enters the iSCSI initiator node name notified from the host apparatus 20 in the iSNS management information (step S131 in FIG. 33).

The connection setting unit 122 enters the initiator IP address allocated to the host port 21 by the DHCP server 15 in the iSNS management information (step S132 in FIG. 33).

The connection setting unit 122 enters the iSCSI target name of the linked-up CA port 13 in the iSCSI port parameter management information (step S133 in FIG. 33).

The connection setting unit 122 enters the initiator IP address acquired from the host apparatus 20 in the iSCSI port parameter management information (step S134 in FIG. 33).

The connection setting unit 122 enters the target IP address of the linked-up CA port 13 in the iSCSI port parameter management information (step S135 in FIG. 33).

The connection setting unit 122 makes iSCSI basic settings between the storage apparatus 10 and the host apparatus 20 (step S136 in FIG. 34).

The connection setting unit 122 makes settings for the target to authenticate the initiator between the storage apparatus 10 and the host apparatus 20 (step S137 in FIG. 34).

The connection setting unit 122 makes settings for the initiator to authenticate the target between the storage apparatus 10 and the host apparatus 20 (step S138 in FIG. 34), and the processing terminates.

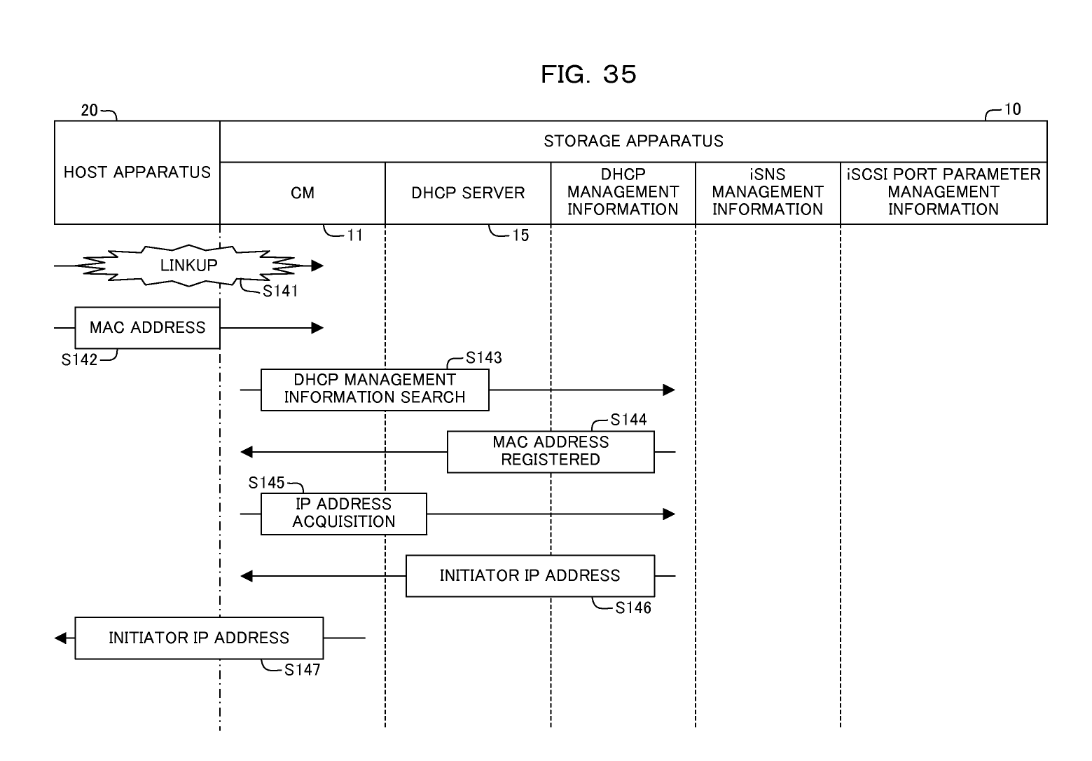

Next, reconnection processing in CM as an example of the second embodiment will be described according to the sequence diagram (steps S141 to S147) illustrated in FIG. 35.

The linkup detector 111 detects a linkup between the storage apparatus 10 and the host apparatus 20, and the CM 11 performs the connection control processing (step S141).

The connection setting unit 122 of the CM 11 acquires the MAC address of the host port 21 from the host apparatus 20 (step S142).

The connection setting unit 122 searches for DHCP management information (step S143).

In the example illustrated in FIG. 35, the connection setting unit 122 recognizes that the MAC address acquired from the host apparatus 20 is already entered in the DHCP management information (step S144).

The connection setting unit 122 acquires the initiator IP address corresponding to the MAC address acquired from the host apparatus 20 from the DHCP management information (steps S145 and S146).

The connection setting unit 122 notifies the host apparatus 20 of the initiator IP address acquired from the DHCP management information (step S147), and the processing terminates.

[B-3] Effect

Thus, according to the CM (connection control apparatus) 11 as an example of the second embodiment, the same effect as that of the CM 11 as an example of the first embodiment can be achieved, and also, for example, the following effect can be achieved.

The connection setting unit 122 creates management information associating identification information to identify the host apparatus 20 and target information to the port 13 of the storage apparatus 10. Also, the connection setting unit 122 makes connection settings to the host apparatus 20 by executing a command created based on the management information. Accordingly, basic settings of iSCSI and authentication settings can automatically be made between the storage apparatus 10 and the host apparatus 20 that are linked up.

The protocol determination unit 121 determines the protocol to the host apparatus 20. When the protocol is determined to be iSCSI by the protocol determination unit 121, the connection setting unit 122 makes connection settings to the host apparatus 20. Accordingly, even when there is a plurality of types of interface between the storage apparatus 10 and the host apparatus 20, basic settings of iSCSI and authentication settings can appropriately be made.

### [C] Others

The disclosed technology is not limited to each of the above embodiments, and can be carried out in various modifications without deviating from the spirit of each embodiment. Each configuration and each piece of processing of each embodiment can be selected as needed or can be combined as appropriate.

In an example of the first embodiment described above, the CPU 110 manages each type of the access processing information 100, the host group information 101, the port group information 103 and the logical volume group information 105 as a table, but the first embodiment is not limited to such an example. The CPU 110 can manage the access processing information 100, the host group information 101, the port group information 103 and the logical volume group information 105 by using various methods.

According to a disclosed connection control apparatus, the procedure for recognition of a logical volume by a higher-level apparatus can be simplified.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A connection control apparatus included in a storage apparatus to control a logical volume allocated to a host apparatus, the connection control apparatus comprising:
a linkup detector that detects a linkup with the host apparatus;
a port information generator that generates port group information containing port information to identify a port of the storage apparatus whose linkup is detected by the linkup detector;
a host information generator that generates host group information containing host information to identify the host apparatus whose linkup is detected by the linkup detector;
a logical volume information generator that generates logical volume group information containing logical volume information to identify the logical volumes of all unallocated logical volumes; and
an access processing information generator that generates access processing information associating the port group information, the host group information, and the logical volume group information.

2. The connection control apparatus according to claim 1, wherein
the logical volume is allocated to a plurality of the host apparatuses being a first host apparatus and a second host apparatus,
when the linkup detector detects the linkup with the second host apparatus before a specified time passes after detecting the linkup with the first host apparatus,
the port information generator enters the port information of each of the first and second host apparatuses in the port group information as a same group and
the host information generator enters the host information of each of the first and second host apparatuses in the host group information as the same group.

3. The connection control apparatus according to claim 1, further comprising:
a linkdown detector that detects a linkdown from the host apparatus, wherein
the logical volume is allocated to a plurality of the host apparatuses being the first host apparatus and the second host apparatus,
when the linkup detector detects a re-linkup with the first host apparatus after the linkdown detector detects the linkdown from the first host apparatus for which the access processing information has been generated and the linkup detector detects the linkup with the second host apparatus before the specified time passes after detecting the re-linkup,
the port information generator enters, in addition to the port information of the first host apparatus acquired before the re-linkup, the port information of the second host apparatus in the port group information as the same group and
the host information generator enters, in addition to the host information of the first host apparatus acquired before the re-linkup, the host information of the second host apparatus in the host group information as the same group.

4. The connection control apparatus according to claim 1, further comprising:
a linkdown detector that detects a linkdown from the host apparatus, wherein
when the linkup detector detects the re-linkup with the host apparatus after the linkdown detector detects the linkdown from the host apparatus for which the access processing information has been generated,
the logical volume information generator enters, in addition to the logical volume information acquired before the re-linkup, the logical volume information of all the logical volumes that are newly added and unallocated in the logical volume group information as the same group.

5. The connection control apparatus according to claim 1, further comprising:
a linkdown detector that detects a linkdown from the host apparatus;
a deletion input processing unit into which a deletion instruction of the port information and the host information is input;
a port information deletion unit that deletes, when an input into the deletion input processing unit arises, the port information of the host apparatus whose linkdown is detected by the linkdown detector from the port group information; and
a host information deletion unit that deletes, when the input into the deletion input processing unit arises, the host information of the host apparatus whose linkdown is detected by the linkdown detector from the host group information.

6. The connection control apparatus according to claim 5, wherein the deletion input processing unit has the deletion instruction of the logical volume group information input thereinto, further comprising:
a logical volume information deletion unit that deletes the logical volume group information when the input into the deletion input processing unit arises and the downlink detector detects the linkdown from all the host apparatuses connected to the storage apparatus.

7. The connection control apparatus according to claim 1, further comprising:
a connection setting unit that sets a connection to the host apparatus by creating management information in which identification information to identify the host apparatus and target information to the port are associated and executing a command created based on the identification information.

8. The connection control apparatus according to claim 7, further comprising:
a protocol determination unit that determines a protocol with the host apparatus, wherein
the connection setting unit sets the connection when the protocol determination unit determines that the protocol is a first protocol.

9. A storage apparatus that controls a logical volume allocated to a host apparatus, the storage apparatus comprising:
a linkup detector that detects a linkup with the host apparatus;
a port information generator that generates port group information containing port information to identify a port of the storage apparatus whose linkup is detected by the linkup detector;
a host information generator that generates host group information containing host information to identify the host apparatus whose linkup is detected by the linkup detector;
a logical volume information generator that generates logical volume group information containing logical volume information to identify the logical volumes of all unallocated logical volumes; and
an access processing information generator that generates access processing information associating the port group information, the host group information, and the logical volume group information.

10. The storage apparatus according to claim 9, wherein
the logical volume is allocated to a plurality of the host apparatuses being a first host apparatus and a second host apparatus,
when the linkup detector detects the linkup with the second host apparatus before a specified time passes after detecting the linkup with the first host apparatus,
the port information generator enters the port information of each of the first and second host apparatuses in the port group information as a same group and
the host information generator enters the host information of each of the first and second host apparatuses in the host group information as the same group.

11. The storage apparatus according to claim 9, further comprising:
a linkdown detector that detects a linkdown from the host apparatus, wherein
the logical volume is allocated to a plurality of the host apparatuses being the first host apparatus and the second host apparatus,
when the linkup detector detects a re-linkup with the first host apparatus after the linkdown detector detects the linkdown from the first host apparatus for which the access processing information has been generated and the linkup detector detects the linkup with the second host apparatus before the specified time passes after detecting the re-linkup,
the port information generator enters, in addition to the port information of the first host apparatus acquired before the re-linkup, the port information of the second host apparatus in the port group information as the same group and
the host information generator enters, in addition to the host information of the first host apparatus acquired before the re-linkup, the host information of the second host apparatus in the host group information as the same group.

12. The storage apparatus according to claims 9, further comprising:
a linkdown detector that detects a linkdown from the host apparatus, wherein
when the linkup detector detects the re-linkup with the host apparatus after the linkdown detector detects the linkdown from the host apparatus for which the access processing information has been generated,
the logical volume information generator enters, in addition to the logical volume information acquired before the re-linkup, the logical volume information of all the logical volumes that are newly added and unallocated in the logical volume group information as the same group.

13. The storage apparatus according to claim 9, further comprising:
a connection setting unit that sets a connection to the host apparatus by creating management information in which identification information to identify the host apparatus and target information to the port are associated and executing a command created based on the identification information.

14. The storage apparatus according to claim 13, further comprising:
a protocol determination unit that determines a protocol with the host apparatus, wherein
the connection setting unit sets the connection when the protocol determination unit determines that the protocol is a first protocol.

15. A non-transitory computer-readable recording medium having stored therein a control program for causing a computer included in a storage apparatus that controls a logical volume allocated to a host apparatus to execute a process comprising:
detecting a linkup with the host apparatus;
generating port group information containing port information to identify a port of the storage apparatus whose linkup is detected;
generating host group information containing host information to identify the host apparatus whose linkup is detected;
generating logical volume group information containing logical volume information to identify the logical volumes of all unallocated logical volumes; and
generating access processing information associating the port group information, the host group information, and the logical volume group information.

16. The non-transitory computer-readable recording medium having stored therein a control program according to claim 15, wherein
the logical volume is allocated to a plurality of the host apparatuses being a first host apparatus and a second host apparatus, the process further comprising:
when the linkup with the second host apparatus is detected before a specified time passes after the linkup with the first host apparatus is detected,
entering the port information of each of the first and second host apparatuses in the port group information as a same group; and
entering the host information of each of the first and second host apparatuses in the host group information as the same group.

17. The non-transitory computer-readable recording medium having stored therein a control program according to claim 15, wherein
the logical volume is allocated to a plurality of the host apparatuses being the first host apparatus and the second host apparatus, the process further comprising:
when a re-linkup with the first host apparatus is detected after a linkdown from the first host apparatus for which the access processing information has been generated is detected and the linkup with the second host apparatus is detected before the specified time passes after the re-linkup is detected,
entering, in addition to the port information of the first host apparatus acquired before the re-linkup, the port information of the second host apparatus in the port group information as the same group and
entering, in addition to the host information of the first host apparatus acquired before the re-linkup, the host information of the second host apparatus in the host group information as the same group.

18. The non-transitory computer-readable recording medium having stored therein a control program according to claim 15, the process further comprising:
when the re-linkup with the host apparatus is detected after the linkdown from the host apparatus for which the access processing information has been generated is detected,
entering, in addition to the logical volume information acquired before the re-linkup, the logical volume information of all the logical volumes that are newly added and unallocated in the logical volume group information as the same group.

19. The non-transitory computer-readable recording medium having stored therein a control program according to claim 15, the process further comprising:
setting a connection to the host apparatus by creating management information in which identification information to identify the host apparatus and target information to the port are associated and executing a command created based on the identification information.

20. The non-transitory computer-readable recording medium having stored therein a control program according to claim 19, the process further comprising:
determining a protocol with the host apparatus; and
setting the connection when the protocol is determined as a first protocol.
